(19) United States
(12) Patent Application Publication
(10) Pub. No.: US 2017/0083882 A1
(43) Pub. Date: Mar. 23, 2017

(54) SECURE PAYMENT METHOD AND ELECTRONIC DEVICE ADAPTED THERETO

(71) Applicant: Samsung Electronics Co., Ltd., Suwon-si (KR)

(72) Inventors: Youngkyoo KIM, Seoul (KR); Suyoung PARK, Uiwang-si (KR)

(21) Appl. No.: 15/257,288

(22) Filed: Sep. 6, 2016

(30) Foreign Application Priority Data
Sep. 22, 2015 (KR) 10-2015-0134224

(51) Int. Cl. G06Q 20/10; G06Q 20/40

(52) U.S. Cl. CPC G06Q 20/102; G06Q 20/40145; G06Q 20/4012

(57) ABSTRACT

A secure payment method and an electronic device adapted to the method are disclosed. The secure payment method includes activating a payment application for making a payment, limiting access to a first resource unrelated to the payment, based on the activated payment application, and performing at least one function related to the payment, using the second resource related to the payment, while limiting access to the first resource.

### CROSS-REFERENCE TO RELATED APPLICATION(S)

This application claims the benefit under 35 U.S.C. §119(a) of a Korean patent application filed on Sep. 22, 2015 in the Korean Intellectual Property Office and assigned Serial number 10-2015-0134224, the entire disclosure of which is hereby incorporated by reference.

### TECHNICAL FIELD

The present disclosure relates to a secure payment method and an electronic device adapted to the method.

### BACKGROUND

With the development of technology, electronic devices have been developed to be equipped with various functions, e.g., a photo taking function, a moving image taking function, etc., as well as a voice call function. Electronic devices have provided network-based communication services as well as multimedia services. Examples of multimedia services are a music service, a moving image service, a digital broadcasting service, a video call, etc. Examples of network-based communication services are a wireless Internet, short message service (SMS), multimedia messaging service (MMS), etc. In recent years, electronic devices have evolved to be equipped with a payment function that payment cards have performed to make a payment off-line. Electronic devices have also been equipped with various types of sensor modules, e.g., an acceleration sensor, a gyro sensor, a red, green, blue (RGB) sensor, an illuminance sensor, etc., so that they can obtain information via the sensors.

Electronic devices have advantages in that one electronic device is equipped with various functions and is also convenient to carry. Therefore, one electronic device may be likely to store user's various information therein. In this case, on the contrary, the convenience of electronic devices may cause contrary results, such as an invasion of privacy, a leakage of information, a security issue, etc. When an electronic device with the user's banking information is exposed to hacking, malicious code, etc., the user may suffer serious damage. For example, in order to make a payment in a store offline, a cardholder hands over a payment card to a clerk and requests payment. This payment manner is normal for the cardholder, in terms of culture, sociality, character, etc. When a user hands over his/her electronic device containing various information to a store clerk and requests to make a payment, this payment manner is very uncomfortable for the user. In particular, since a payment application is activated in the electronic device while its locking function is released, the clerk, etc., receiving the electronic device may access functions other than the payment function without limitation, and thus there may a probability of revealing the user's banking information.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for limiting access to resources unrelated to payment when offline payment using an electronic device is made, and the electronic device adapted to the method.

Another aspect of the present disclosure is to provide a method for preventing a person who receives an electronic device from the electronic device user from accessing functions unrelated to payment of the electronic device user, and the electronic device adapted to the method.

In accordance with an aspect of the present disclosure, a secure payment method of an electronic device is provided. The method includes activating a payment application for making a payment, limiting access to a first resource unrelated to the payment, based on the activated payment application, and performing at least one function related to payment, using the second resource related to payment, while limiting access to the first resource.

In accordance with another aspect of the present disclosure, an electronic device is provided. The electronic device includes a memory configured to store information regarding a plurality of resources including a first and second resources related to a payment, a communication module or transceiver configured to transmit or receive payment information to or from an external device, a display for displaying a user interface (UI), and a processor for activating a payment application for making a payment, limiting access to the first resource unrelated to the payment, based on the activated payment application, and performing at least one function related to the payment, using the second resource related to payment, while limiting access to the first resource.

In accordance with another aspect of the present disclosure, a non-transitory computer-readable recording medium storing a software program is provided. The software program executes activating a payment application for making a payment, limiting access to a first resource unrelated to the payment, based on the activated payment application, and performing at least one function related to the payment, using the second resource related to the payment, while limiting access to the first resource.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description, taken in conjunction with the accompanying drawings, in which:

FIG. 1 illustrates a network environment including an electronic device according to various embodiments of the present disclosure;

FIG. 2 illustrates a block diagram of an electronic device according to various embodiments of the present disclosure;

FIG. 3 is a block diagram illustrating a program module according to various embodiments of the present disclosure;

FIG. 4 is a block diagram illustrating a payment system according to various embodiments of the present disclosure;

FIG. 5 is a block diagram illustrating the hardware architecture of an electronic device capable of performing a payment function according to various embodiments of the present disclosure;

FIG. 6 is a block diagram illustrating program modules executed in an execution environment of an electronic device capable of performing a payment function according to various embodiments of the present disclosure;

FIG. 7 illustrate a payment user interface (UI) of an electronic device, which is displayed when a payment application is activated and a lock function is not selected according to various embodiments of the present disclosure;

FIG. 8 is a block diagram illustrating a hardware configuration of an electronic device 800 according to various embodiments of the present disclosure;

FIG. 9 is a flowchart that describes a secure payment method according to various embodiments of the present disclosure;

FIGS. 10A and 10B illustrate methods of limiting access to a first resource according to various embodiments of the present disclosure;

FIG. 11A is a state diagram of an electronic device according to various embodiments of the present disclosure;

FIG. 11B is a state diagram of an electronic device in a handover mode according to various embodiments of the present disclosure;

FIG. 12 is a flowchart that describes a first example of a secure payment method according to various embodiments of the present disclosure;

FIG. 13 illustrate diagrams that describe the first example of a secure payment method shown in FIG. 12 according to various embodiments of the present disclosure;

FIG. 14 is a flowchart that describes a second example of a secure payment method according to various embodiments of the present disclosure;

FIG. 15 illustrate diagrams that describe the second example of a secure payment method shown in FIG. 14 according to various embodiments of the present disclosure;

FIG. 16 illustrate diagrams that describe a method of setting a lock pattern for a payment screen according to various embodiments of the present disclosure; and

FIG. 17 illustrates diagrams that describe a method of using a one-time password (OTP) according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group phase 1 or phase 2 (MPEG-1 or MPEG-2) audio layer 3 (MP3) player, a portable medical device, a digital camera, or a wearable device (e.g., a head-mounted device (HMD) such as electronic glasses, electronic clothes, an electronic bracelet, an electronic necklace, an electronic appcessory, an electronic tattoo, a smart mirror, or a smart watch).

According to some embodiments, an electronic device may be a smart home appliance that involves a communication function. For example, an electronic device may be a television (TV), a digital video disc (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.)

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device

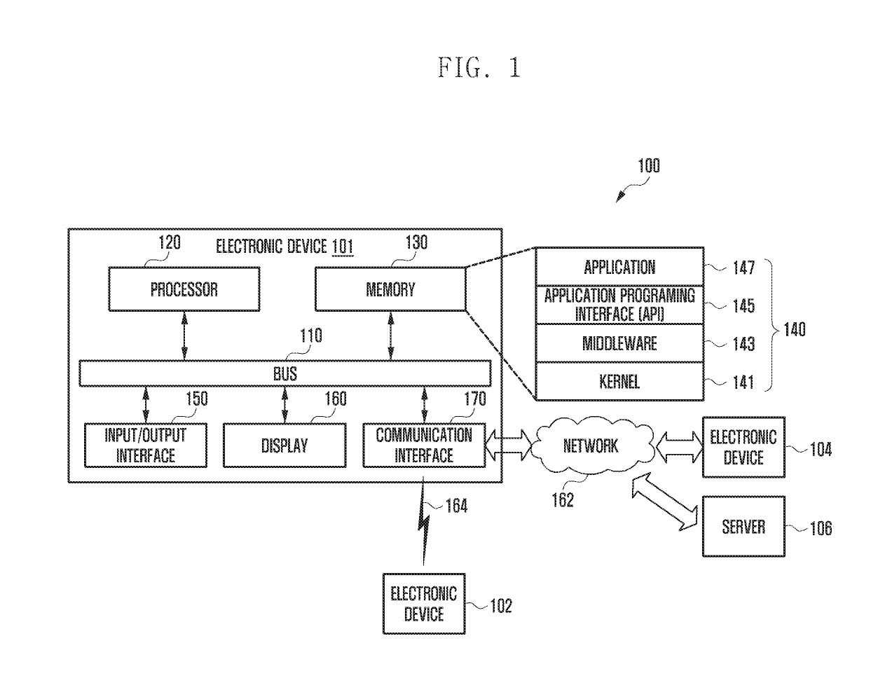

FIG. 1 illustrates a network environment including an electronic device according to various embodiments of the present disclosure.

Referring to FIG. 1, an electronic device 101, in a network environment 100, includes a bus 110, a processor 120, a memory 130, an input/output interface 150, a display 160, and a communication interface 170. According to some embodiments, the electronic device 101 may omit at least one of the components or further include another component.

The bus 110 may be a circuit connecting the above described components and transmitting communication (e.g., a control message) between the above described components.

The processor 120 may include one or more of CPU, AP or communication processor (CP). For example, the processor 120 may control at least one component of the electronic device 101 and/or execute calculation relating to communication or data processing.

The memory 130 may include volatile and/or non-volatile memory. For example, the memory 130 may store command or data relating to at least one component of the electronic device 101. According to some embodiment, the memory may store software and/or program 140. For example, the program 140 may include a kernel 141, middleware 143, an application programming interface (API) 145, and/or an application 147 and so on. At least one portion of the kernel 141, the middleware 143 and the API 145 may be defined as operating system (OS).

The kernel 141 controls or manages system resources (e.g., the bus 110, the processor 120, or the memory 130) used for executing an operation or function implemented by the remaining other program, for example, the middleware 143, the API 145, or the application 147. Further, the kernel 141 provides an interface for accessing individual components of the electronic device 101 from the middleware 143, the API 145, or the application 147 to control or manage the components.

The middleware 143 performs a relay function of allowing the API 145 or the application 147 to communicate with the kernel 141 to exchange data. Further, in operation requests received from the application 147, the middleware 143 performs a control for the operation requests (e.g., scheduling or load balancing) by using a method of assigning a priority, by which system resources (e.g., the bus 110, the processor 120, the memory 130 and the like) of the electronic device 101 may be used, to the application 147.

The API 145 is an interface by which the application 147 may control a function provided by the kernel 141 or the middleware 142 and includes, for example, at least one interface or function (e.g., command) for a file control, a window control, image processing, or a character control.

The input/output interface 150 may be interface to transmit command or data inputted by a user or another external device to another component(s) of the electronic device 101. Further, the input/output interface 150 may output the command or data received from the another component(s) of the electronic device 101 to the user or the another external device.

The display 160 may include, for example, liquid crystal display (LCD), light emitting diode (LED), organic LED (OLED), or micro electro mechanical system (MEMS) display, or electronic paper display. The display 160 may display, for example, various contents (text, image, video, icon, or symbol, and so on) to a user. The display 160 may include a touch screen, and receive touch, gesture, approaching, or hovering input using a part of body of the user.

The communication interface 170 may set communication of the electronic device 101 and external device (e.g., a first external device 102, a second external device 104, or a server 106). For example, the communication interface 170 may be connected with the network 162 through wireless communication or wire communication and communicate with the external device (e.g., a second external device 104 or server 106).

Wireless communication may use, as cellular communication protocol, at least one of long-term evolution (LTE), LTE-advanced (LTE-A), code division multiple access (CDMA), wideband CDMA (WCDMA), universal mobile telecommunications system (UMTS), wireless broadband (WiBro), global system for mobile communications (GSM), and the like, for example. A short-range communication 164 may include, for example, at least one of Wi-Fi, Bluetooth (BT), near field communication (NFC), magnetic secure transmission or near field magnetic data stripe transmission (MST), and global navigation satellite system (GNSS), and the like.

An MST module is capable of generating pulses corresponding to transmission data using electromagnetic signals, so that the pulses can generate magnetic field signals. The electronic device 101 transmits the magnetic field signals to a POS terminal (reader). The POS terminal (reader) detects the magnetic field signal via an MST reader, transforms the detected magnetic field signal into an electrical signal, and thus restores the data.

The GNSS may include at least one of, for example, a GPS, a global navigation satellite system (Glonass), a Beidou navigation satellite system (hereinafter, referred to as “Beidou”), and Galileo (European global satellite-based navigation system). Hereinafter, the “GPS” may be interchangeably used with the “GNSS” in the present disclosure. Wired communication may include, for example, at least one of universal serial bus (USB), high definition multimedia interface (HDMI), recommended standard-232 (RS-232), plain old telephone service (POTS), and the like. The network 162 may include telecommunication network, for example, at least one of a computer network (e.g., local area network (LAN) or wide area network (WAN)), internet, and a telephone network.

Each of the first external device 102 and the second external device 104 may be same type or different type of device with the electronic device 101. According to some embodiment, the server 106 may include one or more group of servers. According to various embodiments, at least one portion of executions executed by the electronic device may be performed by one or more electronic devices (e.g., external electronic device 102, 104, or server 106). According to some embodiments, when the electronic device 101 should perform a function or service automatically, the electronic device 101 may request performing of at least one function to the another device (e.g., external electronic device 102, 104, or server 106). For the above, cloud computing technology, distributed computing technology, or client-server computing technology may be used, for example.

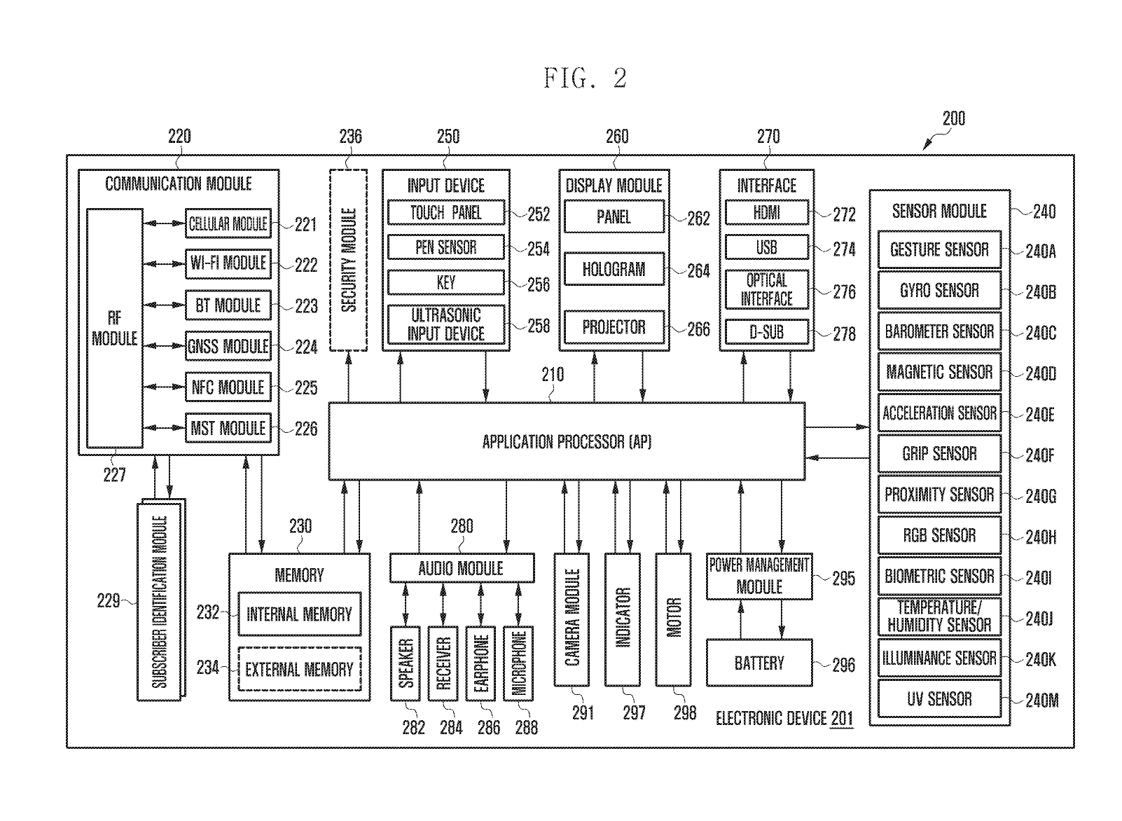

FIG. 2 illustrates a block diagram 200 of an electronic device 101 according to various embodiments of the present disclosure.

Referring to FIG. 2, an electronic device 201 may configure, for example, a whole or a part of the electronic device 101 illustrated in FIG. 1. The electronic device 201 includes one or more APs 210, a communication module 220, a subscriber identification module (SIM) card 229, a memory 230, a sensor module 240, an input device 250, a display module or display 260, an interface 270, an audio module 280, a camera module 291, a power managing module 295, a battery 296, an indicator 297, and a motor 298.

The AP 210 operates an OS or an application program so as to control a plurality of hardware or software component elements connected to the AP 210 and execute various data processing and calculations including multimedia data. The AP 210 may be implemented by, for example, a system on chip (SoC). According to an embodiment, the processor 210 may further include a graphics processing unit (GPU) and/or image signal processor (ISP). The AP 210 may include at least one portion of components illustrated in FIG. 2 (e.g., a cellular module 221). The AP 210 may load command or data received from at least one of another component (e.g., non-volatile memory), store various data in the non-volatile memory.

The communication module 220 may include same or similar components with the communication interface 170 of FIG. 1. The communication module 220, for, example, may include the cellular module 221, a Wi-Fi module 222, a BT module 223, a GPS module 224, a NFC module 225, a MST module 226, and a radio frequency (RF) module 227.

The cellular module 221 provides a voice, a call, a video call, a short message service (SMS), or an internet service through a communication network (e.g., LTE, LTE-A, CDMA, WCDMA, UMTS, WiBro, GSM and the like). Further, the cellular module 221 may distinguish and authenticate electronic devices within a communication network by using a SIM (e.g., the SIM card 229). According to an embodiment, the cellular module 221 performs at least some of the functions which may be provided by the AP 210. For example, the cellular module 221 may perform at least some of the multimedia control functions. According to an embodiment, the cellular module 221 may include a CP.

Each of the Wi-Fi module 222, the BT module 223, the GPS module or GNSS module 224, and the NFC module 225 may include, for example, a processor for processing data transmitted/received through the corresponding module. Although the cellular module 221, the Wi-Fi module 222, the BT module 223, the GPS module 224, and the NFC module 225 are at least some (e.g., two or more) of the cellular module 221, the Wi-Fi module 222, the BT module 223, the GPS module 224, and the NFC module 225 may be included in one integrated chip (IC) or one IC package according to one embodiment. For example, at least some (e.g., the CP corresponding to the cellular module 221 and the Wi-Fi processor corresponding to the Wi-Fi module 222 of the processors corresponding to the cellular module 221, the Wi-Fi module 222, the BT module 223, the GPS module 224, and the NFC module 225 may be implemented by one SoC.

The RF module 227 transmits/receives data, for example, an RF signal. Although not illustrated, the RF module 227 may include, for example, a transceiver, a power amp module (PAM), a frequency filter, a low noise amplifier (LNA) and the like. Further, the RF module 227 may further include a component for transmitting/receiving electronic waves over a free air space in wireless communication, for example, a conductor, a conducting wire, and the like. Although the cellular module 221, the Wi-Fi module 222, the BT module 223, the GPS module 224, and the NFC module 225 share one RF module 227 in FIG. 2, at least one of the cellular module 221, the Wi-Fi module 222, the BT module 223, the GPS module 224, and the NFC module 225 may transmit/receive an RF signal through a separate RF module according to one embodiment.

The SIM card 229 is a card including a SIM and may be inserted into a slot formed in a particular portion of the electronic device. The SIM card 229 includes unique identification information (e.g., integrated circuit card identifier (ICCID)) or subscriber information (e.g., international mobile subscriber identity (IMSI).

The memory 230 (e.g., memory 130) may include an internal memory 232 or an external memory 234. The internal memory 232 may include, for example, at least one of a volatile memory (e.g., a random access memory (RAM), a dynamic RAM (DRAM), a static RAM (SRAM), a synchronous DRAM (SDRAM), and the like), and a non-volatile Memory (e.g., a read only memory (ROM), a one time programmable ROM (OTPROM), a programmable ROM (PROM), an erasable and programmable ROM (EPROM), an electrically erasable and programmable ROM (EEPROM), a mask ROM, a flash ROM, a not and (NAND) flash memory, a not or (NOR) flash memory, and the like).

According to an embodiment, the internal memory 232 may be a solid state drive (SSD). The external memory 234 may further include a flash drive, for example, a compact flash (CF), a secure digital (SD), a micro-SD, a mini-SD, an extreme digital (xD), or a memory stick. The external memory 234 may be functionally connected to the electronic device 201 through various interfaces. According to an embodiment, the electronic device 201 may further include a storage device (or storage medium) such as a hard drive.

The security module 236 refers to a module with a storage space which has a relatively higher level of security than the memory 230. The security module 236 may be a circuit guaranteeing an execution environment where data is securely stored and protected. The security module 236 may also be implemented with a separate circuit, including an additional processor. The security module 236 may be installed into, e.g., a detachable smart chip, an SD card, or the like. Alternatively, the security module 236 may include an embedded secure element (eSE) built in a fixed chip of the electronic device 201. In addition, the security module 236 may run through an OS which differs from that of the electronic device 201. For example, the security module 236 may run based on a java card open platform (JCOP).

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor or RGB sensor 240H (e.g., red, green, and blue (RGB) sensor) 240H, a biometric sensor 240I, a temperature/humidity sensor 240J, an illumination (light) sensor 240K, and an ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) stylus or (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 may recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which may detect an acoustic wave by a microphone (e.g., a microphone 288) of the electronic device 201 through an input means generating an ultrasonic signal to identify data and may perform wireless recognition. According to an embodiment, the electronic device 201 receives a user input from an external device (e.g., computer or server) connected to the electronic device 201 by using the communication module 220.

The display 260 (e.g., display 160) includes a panel 262, a hologram device 264, and a projector 266. The panel 262 may be, for example, a LCD or an active matrix OLED (AM-OLED). The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 201. According to an embodiment, the display 260 may further include a control circuit for controlling the panel 262, the hologram device 264, and the projector 266.

The interface 270 includes, for example, a HDMI 272, an USB 274, an optical interface 276, and a D-subminiature (D-sub) 278. The interface 270 may be included in, for example, the communication interface 170 illustrated in FIG. 1. Additionally or alternatively, the interface 270 may include, for example, a mobile high-definition link (MHL) interface, an SD card/multi-media card (MMC), or an infrared data association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 and the like.

The camera module 291 is a device which may photograph a still image and a video. According to an embodiment, the camera module 291 may include one or more image sensors (e.g., a front sensor or a back sensor), an ISP (not shown) or a flash (e.g., an LED or xenon lamp).

The power managing module 295 manages power of the electronic device 201. Although not illustrated, the power managing module 295 may include, for example, a power management integrated circuit (PMIC), a charger IC, or a battery or fuel gauge.

The PMIC may be mounted to, for example, an integrated circuit or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier and the like may be added.

The battery fuel gauge measures, for example, a remaining quantity of the battery 296, or a voltage, a current, or a temperature during charging. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (e.g., AP 210) of the electronic device 201, for example, a booting status, a message status, a charging status and the like. The motor 298 converts an electrical signal to a mechanical vibration. Although not illustrated, the electronic device 201 may include a processing unit (e.g., GPU) for supporting a module TV. The processing unit for supporting the mobile TV may process, for example, media data according to a standard of digital multimedia broadcasting (DMB), digital video broadcasting (DVB), media flow and the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

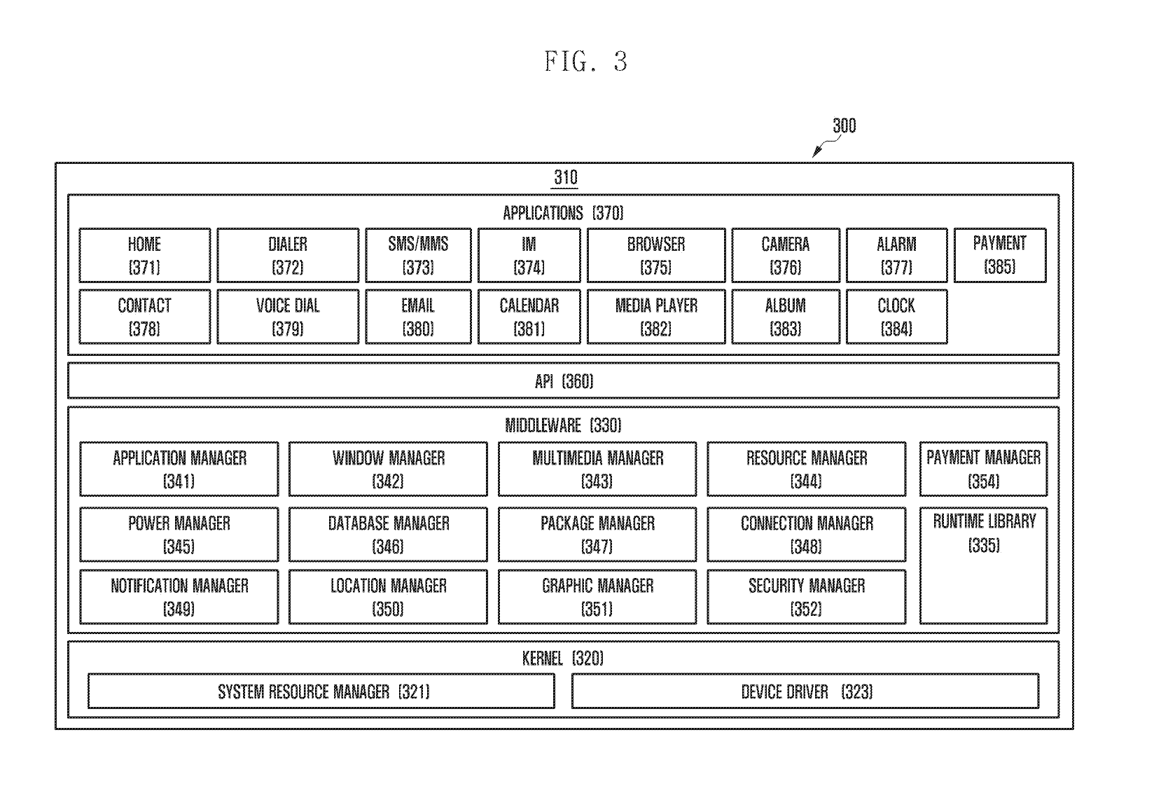

FIG. 3 is a block diagram 300 illustrating a programming module according to various embodiments of the present disclosure.

Referring to FIG. 3, a programming module 310 may be included, e.g. stored, in the electronic apparatus 100, e.g. the memory 130, as illustrated in FIG. 1. At least a part of the programming module 310 (e.g., program 140) may be configured by software, firmware, hardware, and/or combinations of two or more thereof. The programming module 310 may include an OS that is implemented in hardware, e.g., the hardware 200 to control resources related to an electronic device, e.g., the electronic device 100, and/or various applications. e.g., applications 370, driven on the OS. For example, the OS may be Android®, iOS®, Windows®, Symbian®, Tizen®, Bada®, and the like. Referring to FIG. 3, the programming module 310 may include a kernel 320, middleware 330, an API 360, and the applications 370 (e.g., application 147). At least a part of the program module 310 may be preloaded on the electronic device or downloaded from a server (e.g., an electronic device 102, 104, server 106, etc.).

The kernel 320, which may be like the kernel 141, may include a system resource manager 321 and/or a device driver 323. The system resource manager 321 may include, for example, a process manager, a memory manager, and a file system manager. The system resource manager 321 may control, allocate, and/or collect system resources. The device driver 323 may include, for example, a display driver, a camera driver, a BT driver, a shared memory driver, a USB driver, a keypad driver, a Wi-Fi driver, and an audio driver. Further, according to an embodiment, the device driver 323 may include an inter-process communication (IPC) driver (not illustrated).

The middleware 330 may include a plurality of modules implemented in advance for providing functions commonly used by the applications 370. Further, the middleware 330 may provide the functions through the API 360 such that the applications 370 may efficiently use restricted system resources within the electronic apparatus. For example, as shown in FIG. 3, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352 and a payment manager 354.

The runtime library 335 may include a library module that a compiler uses in order to add a new function through a programming language while one of the applications 370 is being executed. According to an embodiment, the runtime library 335 may perform an input/output, memory management, and/or a function for an arithmetic function.

The application manager 341 may manage a life cycle of at least one of the applications 370. The window manager 342 may manage graphical user interface (GUI) resources used by a screen. The multimedia manager 343 may detect formats used for reproduction of various media files, and may perform encoding and/or decoding of a media file by using a codec suitable for the corresponding format. The resource manager 344 may manage resources such as a source code, a memory, and a storage space of at least one of the applications 370.

The power manager 345 may manage a battery and/or power, while operating together with a basic input/output system (BIOS), and may provide power information used for operation. The database manager 346 may manage generation, search, and/or change of a database to be used by at least one of the applications 370. The package manager 347 may manage installation and/or an update of an application distributed in a form of a package file.

For example, the connectivity manager 348 may manage wireless connectivity such as Wi-Fi or BT. The notification manager 349 may display and/or notify of an event, such as an arrival message, a promise, a proximity notification, and the like, in such a way that does not disturb a user. The location manager 350 may manage location information of an electronic apparatus. The graphic manager 351 may manage a graphic effect which will be provided to a user, and/or a user interface (UI) related to the graphic effect. The security manager 352 may provide all security functions used for system security and/or user authentication. According to an embodiment, when an electronic apparatus, e.g., the electronic apparatus 100, has a telephone call function, the middleware 330 may further include a telephony manager (not illustrated) for managing a voice and/or video communication function of the electronic apparatus. The payment manger 354 is capable of relaying payment information from the application 370 to an application 370 or a kernel 320. Alternatively, the payment manager 354 is capable of storing payment-related information received from an external device in the electronic device 200 or transmitting information stored in the electronic device 200 to an external device.

The middleware 330 may generate and use a new middleware module through various functional combinations of the aforementioned internal element modules. The middleware 330 may provide modules specialized according to types of OSs in order to provide differentiated functions. Further, the middleware 330 may dynamically remove some of the existing elements and/or add new elements. Accordingly, the middleware 330 may exclude some of the elements described in the various embodiments of the present disclosure, further include other elements, and/or substitute the elements with elements having a different name and performing a similar function.

The API 360, which may be similar to the API 133, is a set of API programming functions, and may be provided with a different configuration according to the OS. For example, in a case of Android or iOS, one API set may be provided for each of platforms, and in a case of Tizen, two or more API sets may be provided.

The applications 370, which may include an application similar to the application 147, may include, for example, a preloaded application and/or a third party application. The applications 370 may include one or more of the following: a home application 371 a dialer application 372, an SMS/multimedia messaging service (MMS) application 373, an instant messaging (IM) application 374, a browser application 375, a camera application 376, an alarm application 377, a contact application 378, a voice dial application 379, an email application 380, a calendar application 381, a media player application 382, an album application 383, a clock application 384, a payment application 385, a health care application (not shown) (e.g., the measurement of blood pressure, exercise intensity, etc.), an application (not shown) for providing environment information (e.g., atmospheric pressure, humidity, temperature, etc.), etc. However, the present embodiment is not limited thereto, and the applications 370 may include any other similar and/or suitable application.

According to an embodiment, the applications 370 are capable of including an application for supporting information exchange between an electronic device (e.g., electronic device 101) and an external device (e.g., electronic devices 102 and 104), which is hereafter called ‘information exchange application’). The information exchange application is capable of including a notification relay application for relaying specific information to external devices or a device management application for managing external devices.

For example, the notification relay application is capable of including a function for relaying notification information, created in other applications of the electronic device (e.g., SMS/MMS application, email application, health care application, environment information application, etc.) to external devices (e.g., electronic devices 102 and 104). In addition, the notification relay application is capable of receiving notification information from external devices to provide the received information to the user.

The device management application is capable of managing (e.g., installing, removing or updating) at least one function of an external device (e.g., electronic devices 102 and 104) communicating with the electronic device. Examples of the function are a function of turning-on/off the external device or part of the external device, a function of controlling the brightness (or resolution) of the display, applications running on the external device, services provided by the external device, etc. Examples of the services are a call service, messaging service, etc.

According to an embodiment, the applications 370 are capable of including an application (e.g., a health care application of a mobile medical device, etc.) specified attributes of an external device (e.g., electronic devices 102 and 104). According to an embodiment, the applications 370 are capable of including applications received from an external device (e.g., a server 106, electronic devices 102 and 104). According to an embodiment, the applications 370 are capable of including a preloaded application or third party applications that can be downloaded from a server. It should be understood that the components of the program module 310 may be called different names according to types of OSs.

According to various embodiments, at least a part of the program module 310 can be implemented with software, firmware, hardware, or any combination of two or more of them. At least a part of the program module 310 can be implemented (e.g., executed) by a processor (e.g., processor 210). At least a part of the programing module 310 may include modules, programs, routines, sets of instructions or processes, etc., in order to perform one or more functions.

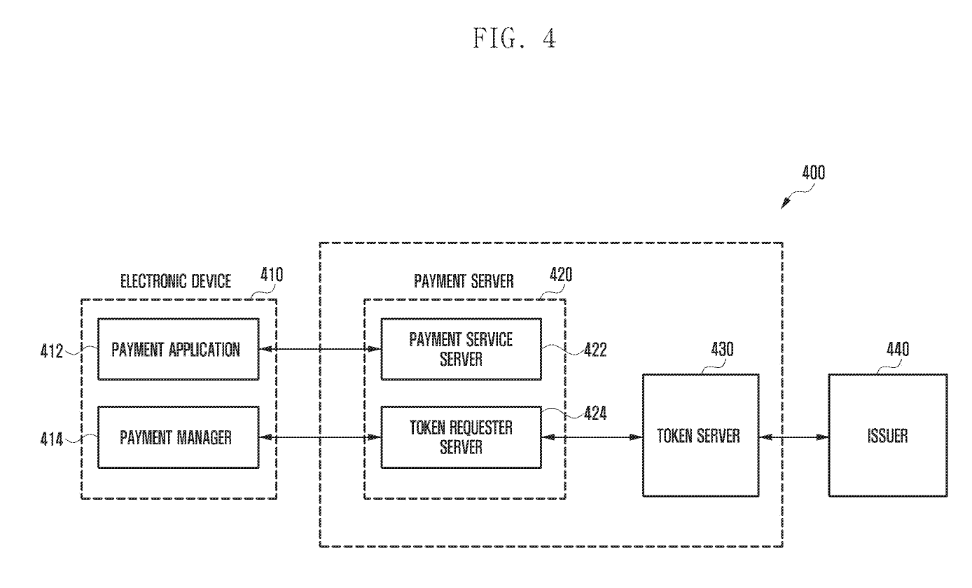

FIG. 4 is a block diagram illustrating a payment system 400 according to various embodiments of the present disclosure.

Referring to FIG. 4, the payment system 400 is capable of including an electronic device 410 and/or a server. The server is capable of including a payment server 420, a token server (a token service provider (TSP)) 430, or an issuer 440. The electronic device 410 is capable of including a payment application (or wallet application) 412 and/or a payment manager 414. The payment server 420 is capable of including a payment service server 422 and/or a token requester server (token requester) 424.

In various embodiments, the payment application 412 may include, for example, Samsung Pay™ Application. The payment application 412 is capable of providing UI or user experience (UX) related to payment. The payment-related UI may include wallet UI/UX. For example, the payment application 412 may provide UI related to card registration, payment, transaction, etc. The payment application 412 may provide interface related to card registration using an optical character reader/recognition (OCR) or external inputs (e.g., user inputs). The payment application 412 may provide interface related to user authentication via identification & verification (ID&V).

In various embodiments, the electronic device 410 is capable of performing payment or transaction, using the payment application 412. For example, the payment application 412 may provide the user with a payment function by executing a preset application, Simple Pay or Quick Pay. The user of the electronic device 410 runs the payment application 412 to make a payment and is provided with information related to the payment function.

In various embodiments, the payment manager 414 may include information related to card issuing companies. For example, the payment manger 414 may include a software development kit (SDK) of a card issuing company.

In various embodiments, the payment server 420 is capable of including a management server configured to perform an electronic payment or a mobile payment. The payment server 420 is capable of receiving payment-related information from the electronic device 410 and transmitting the information to the outside or processing the information.

In various embodiments, the payment server 420 is capable of transmitting information between the electronic device 410 and the token server 430, using the payment service server 422 and/or the token requester server 424. The payment service server 422 is capable of including a payment server 420 (e.g., a Samsung payment server). The payment service server 422 is capable of managing card information associated with a user's account or service account (e.g., Samsung account). The payment service server 422 is capable of including an API server related to the payment application 412. The payment service server 422 is capable of providing an account managing module (e.g., account integration or Samsung account integration).

In various embodiments, the token requester server 424 is capable of providing interface for processing payment-related information. For example, the token requester server 424 is capable of issuing, deleting or activating payment-related information (e.g., token). The token requester server 424 is capable of controlling information required for payment, while being functionally connected with the payment manager 414.

In various embodiments, the payment application 412 of the electronic device 410 is functionally connected to the payment service server 422 of the payment server 420. For example, the payment application 412 is capable of transmitting/receiving payment-related information to/from the payment server 420. In an embodiment, the payment manager 414 of the electronic device 410 is functionally connected to the token requester server 424 of the payment server 420. For example, the payment manager 414 is capable of transmitting/receiving payment-related information to/from the token requester server 424.

In various embodiments, the token server 430 is capable of issuing or managing payment-related information (e.g., token). For example, the token server 430 is capable of controlling a life cycle of token and performing creation, modification and deletion of token during the life cycle of token. The token server 430 is capable of including a token managing server. In this case, the token server 430 is capable of performing token-provisioning, authentication via ID&V, replenishment, management of life cycle, and integration of information related to an issuer.

In various embodiments, the payment server 420 and/or the token server 430 may be located in the same area or a similar area or in separated individual areas. For example, the payment server 420 may be included in a first server and the token server 430 may be included in a second server. Alternatively, the payment server 420 and/or the token server 430 may be implemented within one server (e.g., a first server or a second server), but distinguished from each other therein.

In various embodiments, the issuer 440 is capable of issuing cards. For example, the issuer 440 is capable of including a card issuing banking server. The issuer 440 is capable of creating payment-related information to be provided to users. The payment-related information created by the issuer 440 may be stored in the electronic device 410 by using the payment application 412. The issuer 440 is functionally connected to the token server 430 and transmits/receives payment-related information thereto/therefrom.

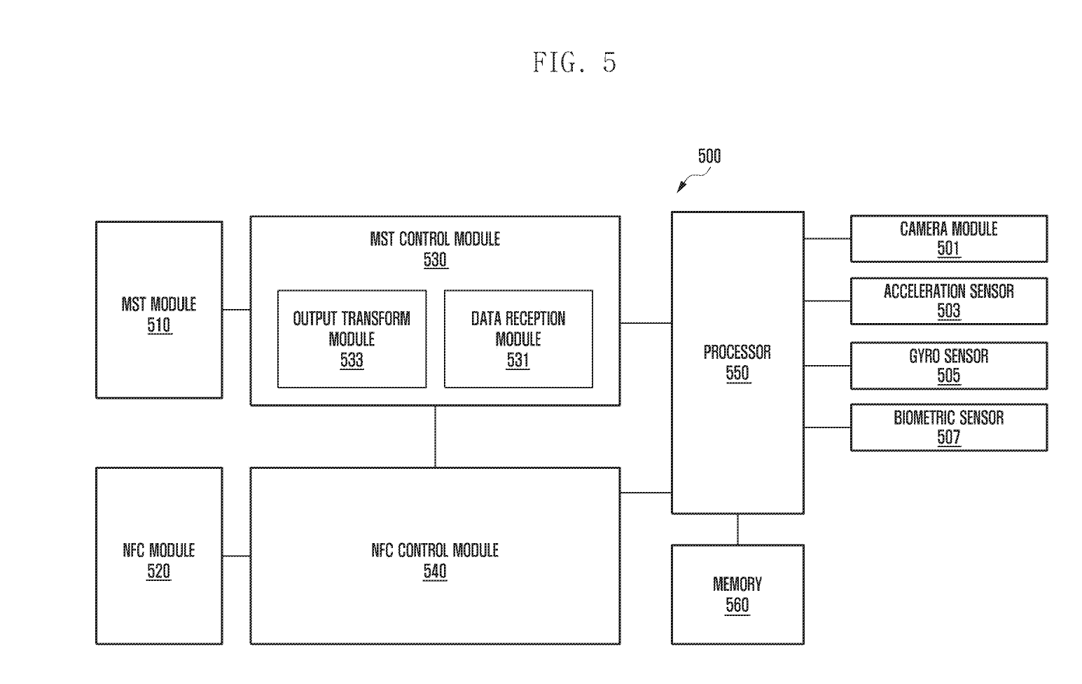

FIG. 5 is a block diagram 500 illustrating a hardware architecture of an electronic device (e.g., electronic device 101) capable of performing a payment function according to various embodiments of the present disclosure.

Referring to FIG. 5, the electronic device is capable of including a camera module 501, an acceleration sensor 503, a gyro sensor 505, a biometric sensor 507, an MST module 510, an NFC module 520, an MST control module 530, an NFC control module 540, a processor 550, and a memory 560. The camera module 501 takes an image of a card to make a payment and obtains the card information. The camera module 501 is capable of recognizing card information (e.g., card issuing company, card number, expiration date, card holder name, etc.) written on a card, via an OCR function. Alternatively, a user may directly input card information to his/her electronic device, using an input device of the electronic device, e.g., a touch panel, a pen sensor, keys, an ultrasonic input system, a microphone, etc.

The NFC module 520 is capable of performing NFC. In various embodiments, the NFC module 520 is capable of including an antenna and an NFC chipset. In various embodiments, the NFC chipset is capable of including circuit devices to operate in reader/writer mode, P2P mode or Card Emulation mode. When the NFC module 520 in reader/writer mode recognizes an NFC tag within an RF Field coverage (hereinafter called NFC tagging), it is capable of reading out information recorded in the NFC tag (in reader mode) or recording or modifying information in the NFC tag (in write mode). When the NFC module 520 is located close to an NFC terminal with an NFC chipset, e.g., POS terminal (reader), it is capable of transmitting payment information to the POS terminal (reader).

The NFC control module 540 executes a payment application to activate an NFC function of the NFC module 520, so that the electronic device with a payment function (e.g., electronic device 101) can make a payment.

In various embodiments, the electronic device is capable of obtaining its state information via various sensor modules (e.g., sensor module 240) and using the state information in the payment process. The processor 550 is capable of controlling the sensor modules (e.g., acceleration sensor 503 or gyro sensor 505) to obtain location information regarding the electronic device when payment is performed. The processor 55p receives the obtained location information from the sensor modules and controls the intensity of magnetic fields emitted from the antenna of the MST module 510 (the amount of current supplied to an antenna) to a POS terminal (reader), based on the location information regarding the electronic device. Alternatively, when the MST module 510 has a number of coil antennas, the processor 550 may select a coil antenna which is used. In an embodiment, the MST control module 530 is capable of including a data reception module 531 and an output transform module 533. The data reception module 531 is capable of receiving a logical high/low pulse signal containing payment information from the processor 550 or a security module (e.g., eSE).

The output transform module 533 is capable of including a circuit configured to transform data, recognized by the data reception module 531, to a corresponding format of data and transmit the transformed data to the MST module 510. The circuit may include an H-bridge configured to alternate the polarity of voltage supplied to both ends of the MST module 510. The H-bridge may be configured with four switching devices connected to each other as in the letter ‘H.’

In various embodiments, the electronic device (e.g., electronic device 101) is capable of receiving card information via its various input systems. Examples of the various input systems are a camera module 501 (e.g., camera module 291) or an input device (e.g., input device 250). When the electronic device receives card information via the camera module 501 or an input device (e.g., a touch panel, a pen sensor, etc.), it is capable of: receiving payment information (e.g., Track 1, Track 2, Track 3 or token information), contained in the magnetic strip of the magnetic card, from a card issuing company/bank server, via a communication module (not shown), based on the received card information; and storing the payment information in a corresponding format in the processor 550 or a separate security module 236 (e.g., eSE).

In various embodiments, the electronic device is capable of obtaining a user's biometric information (e.g. fingerprint) via the biometric sensor 507 (e.g., biometric sensor 240I), and using the obtained biometric information as an authentication means for payment. When the processor 550 controls the biometric sensor 507 to obtain a user's biometric information and obtains the biometric information via the biometric sensor 570, it is capable of comparing the obtained biometric information with a user's first stored biometric information, thereby authenticating the user.

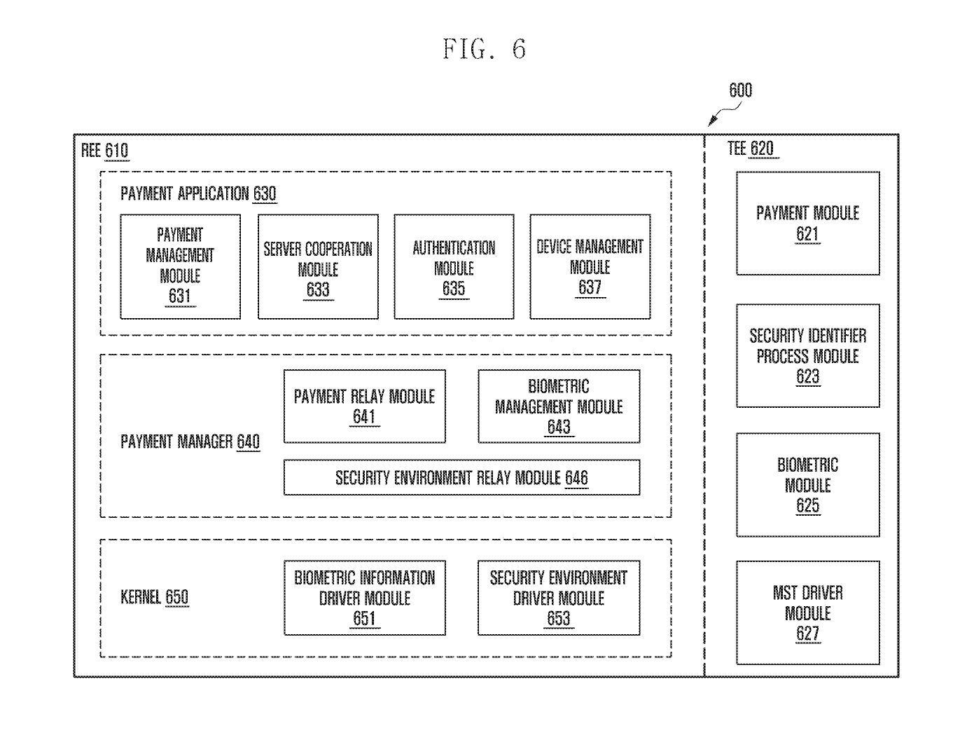

FIG. 6 is a block diagram 600 illustrating program modules executed in an execution environment of an electronic device (e.g., electronic device 101) capable of performing a payment function according to various embodiments of the present disclosure. Referring to FIG. 6, the execution environment may include, e.g., REE (Rich Execution Environment) 610 and TEE (Trusted Execution Environment) 620.

Referring to FIG. 6, in order to perform a payment, the REE 610 is capable of including a payment application 630 (e.g., payment application 385), a payment manager 640 (e.g., payment manager 354), and a kernel 650 (e.g., kernel 320). In an embodiment, the payment application 630 is capable of including a payment management module 631, a server cooperation module 633, an authentication module 635, and/or a device management module 637.

In an embodiment, the payment management module 631 is capable of performing card registration, card authentication, card information deletion, and payment. The payment management module 631 is capable of registering a user's cards. The electronic device (e.g., electronic device 101) is capable of receiving a card registration request from the user. The electronic device is capable of obtaining an image of a card via the camera module (e.g., camera module 291). The payment management module 631 is capable of obtaining a card image via an OCR module (not shown). The payment management module 631 is capable of receiving information related to card information (e.g., password, home address, email address, phone number, account ID, etc.) from the user or a payment server (e.g., payment server 420).

In an embodiment, the payment management module 631 is capable of displaying a registered card on the display 160 functionally connected to the electronic device. The user may alter part of the information regarding the registered card (e.g., card name, home address, phone number, the number of payment attempts, a setting of a condition as to whether to receive payment notification information, etc.). The payment management module 631 is capable of displaying transaction details of individual cards. The payment management module 631 is capable of displaying information regarding cards registered in a wearable device (e.g., a smart watch) functionally connected to the electronic device.

In an embodiment, the payment management module 631 is capable of making a payment using the registered card. The user selects one of a number of registered cards in order to make a payment. The user moves his/her electronic device to a POS terminal (reader). The payment management module 631 receives information regarding a product (e.g., price) from the POS terminal (reader) and displays the information on the display 160. The payment management module 631 performs user authentication for payment, e.g., fingerprint authentication, via the authentication module 635. When completing the authentication, the payment management module 631 displays a message notifying of payment completion on the display 160.

In an embodiment, the electronic device (e.g., electronic device 101) is capable of transmitting payment information to the POS terminal (reader) using the MST module and/or the NFC module. In order to increase the recognition rate, the electronic device may transmit payment information to the POS terminal (reader) using the MST module and the NFC module simultaneously. Alternatively, when the electronic device transmits payment information to the POS terminal (reader) using the MST module but fails to make the payment, it may transmit payment information to the POS terminal (reader) using the NFC module. The electronic device may recognize payment failure as it receives a notification from, e.g., the POS terminal (reader) or a 3^{rd} party (e.g., financial institution), or when a preset period of time has elapsed. It should be understood that the various embodiments are not limited to the order of operations described above but may be performed in any other sequence, e.g., reverse order.

In an embodiment, the electronic device receives a user input requesting the deleting information regarding at least one of the registered cards. The payment management module 631 deletes information regarding a corresponding card from the memory 130. The payment management module 631 may request information regarding at least one of the registered cards from the payment server.

In an embodiment, the payment management module 631 is capable of verifying whether an owner of a card is identical to a person who performs registration of the card. The payment management module 631 is capable of including, e.g., an ID&V module. The payment management module 631 is capable of performing user authentication via text messages, emails, ARS, or phone calls. Alternatively, user authentication may be performed via an application issued from a card issuing company or a bank. When a registered card is authenticated via the payment management module 631, it can be used.

In an embodiment, the payment management module 631 is capable of including an OCR module. The OCR module is capable of converting images, obtained as a scanner scans documents containing words, letters or characters written by a person or printed by a printing machine, into readable or editable data (characters) by a machine The electronic device is capable of obtaining an image of a user's card captured by a camera module (e.g., camera module 291). The OCR module is capable of converting an image, words, letters or characters, and numbers in the captured card image into readable or editable data (characters) by a machine The OCR module is capable of obtaining a user's card information (e.g., card number, user name, or expiration date) from the converted data. The electronic device is capable of obtaining a user's card information via the OCR module and performing a card registration process based on the obtained information.

In an embodiment, the payment management module 631 is capable of displaying a barcode generated for payment on the display 160. For example, the payment management module 631 is capable of receiving, from a POS terminal (reader), a command for generating a barcode that a barcode reader reads when making a payment. The payment management module 631 is capable of generating a barcode based on the command

In an embodiment, the server cooperation module 633 is capable of receiving a payment-related message, a device-related message, or a service-related message from a payment server or a TSP. The server cooperation module 633 is capable of transmitting the message to the payment management module 631.

In an embodiment, the server cooperation module 633 is capable of including a push management module (not shown) and/or an account management module (not shown). For example, when the server cooperation module 633 receives, from the payment server, a token-related message i.e., a push notification, the push management module handles the received message. When the server cooperation module 633 receives a message containing account-related information (e.g., Samsung account), the account management module handles the received message.

In an embodiment, the push management module is capable of operating or handling a push notification or push message received from the payment server. The push message may be transferred to a server cooperation module 633 in the payment application 630 via a payment relay module 641 in the payment manager 640 or 354. Alternatively, the push message may be directly transferred to the payment application 630. At least a part of the received push message is transferred to the payment management module 631 and is used for updating card-related information, thereby synchronizing with the payment server.

In an embodiment, the payment service is capable of including an account server configured to manage account information or a token requester server configured to provide payment-related information. The account server and the token requester server may be implemented with individual separate devices (e.g., server 106) or to be included in a single device.

In an embodiment, the message information received from the push management module may contain information related to token and payment, such as authority setting (e.g., token provisioning), suspension (e.g., token suspension), disposal (e.g., token disposal), status change (e.g., token status change), replenishment (e.g., token replenishment), payment ID (e.g., transaction notification), etc. as in the following table 1.

The message transmitted/received to/from the account management module may contain at least a part of the information related to the electronic device, such as a function for identifying a lost electronic device (e.g., lost device, find my mobile), a remote blocking function (e.g., remote lock/unlock), a membership managing function (e.g., loyalty/membership cards), a website cooperation function (e.g., website portal-online), etc.

TABLE 1

| Push | | |
|---|---|---|
| management | Use case | Details |
| Token | Token provisioning | External server provides a push management |
| | with ID & V | module of an electronic device with card |
| | | information for identification and verification in |
| | | order to install token and perform authentication |
| | Token suspension | External server transmits information for token |
| | | suspension to a push management module of an |
| | | electronic device |
| | Token resume | External server transmits information for token |
| | | resumption to a push management module of an |
| | | electronic device |
| | Token disposal | External server transmits information for token |
| | | disposal to a push management module of an |
| | | electronic device |
| | Token status change | External server transmits information for card |
| | | status change to a push management module of an |
| | | electronic device |
| | Token | External server transmits information for token |
| | Replenishment | replenishment to a push management module of an |
| | | electronic device |
| | Transaction | External server (payment server) transmits token |
| | Notification | payment details to a push management module of |
| | | an electronic device |
| Device | Lost Device (Find | Lost details are transmitted between an external |
| | my mobile) | server (service server) and an account |
| | | management module of an electronic device |
| | Remote lock/unlock | Commands for blocking remote devices are |
| | | transmitted between an external server (service |
| | | server) and an account management module of an |
| | | electronic device |
| | Loyalty/Membership | Membership information is transmitted between an |
| | cards | external server (service server) and an account |
| | | management module of an electronic device |
| | Website (online) | A website cooperation function is supported |
| | | between an external server (service server) and an |
| | | account management module of an electronic |
| | | device |

In an embodiment, when token provisioning with ID & V information obtained by a payment management module has been successfully transmitted to an external server via a payment server and the transmitted token-related information is validated, the server cooperation module 633 receives a message, e.g., “push token {id} status changed,” and transmits the message to the payment management module 631.

In an embodiment, temporary suspension of card information (e.g., token suspension) obtained by the payment management module 631 transmits the use suspension command from the payment server to the payment application 630, thereby changing the card setup state for mobile payment from an active state to an inactive state.

In an embodiment, when an electronic device is lost, the payment server is capable of deleting all of its stored token information or temporarily suspending the token information. In order to synchronize this result with the payment application 630, the payment server may transmit a push message to the payment application 630. The payment server may transmit the push message to the payment application 630 via the payment management module 631 or the server cooperation module 633 (e.g., a push management module or an account management module).

Referring to the following table 2, details of a push API supported by an electronic device and a payment management module 631 are implemented to be distinguished from each other according to the payment management module 631.

TABLE 2

| API | Description | type | validation |
|---|---|---|---|
| device.push | Contains push platform | Json | required |
| device.push.spp.id | Samsung Push Id. | String | required |
| device.push.gcm.id | Google Push Id. | String | optional |

In an embodiment, the account management module is capable of managing information to be exchanged with a payment server, e.g., a user's unique identifier (e.g., a Samsung account id or a device id), card information, membership information, etc., via the payment application. The user identifier may include a user's subscription accounts to manage a number of business-related cards (e.g., Visa card or Master card), a portal account related to an electronic device, a unique identifier of an electronic device (e.g., a model name, media access control (MAC) address, international mobile equipment identity (IME), a serial number, a universally unique identifier (UUID), ID, etc. The unique identifier may be a value that the payment server generates and may receive the value via the account.

The account management module is capable of managing registration, replenishment, deletion, duplicate registration, use suspension, or use resumption for cards, using a user's account or an identifier of an electronic device. In addition, when card information is imported/exported between an electronic device and a wearable device, the account management module is capable of managing registration, replenishment, deletion, duplicate registration and ID, use suspension, or use resumption for cards, based on a user's generated account or an electronic device identity. In this case, the account-based card management method manages a number of users or a number of electronic devices, sharing one account, in such a way as to: allow the electronic devices to use unique accounts (e.g., Samsung accounts) respectively; or integrally manage the electronic devices using one account.

In an embodiment, information regarding a first card (e.g., Visa card) and a second card (e.g., Master card), generated by a recognition module (e.g., OCR module) of the payment management module 631, may be used to register the card based on an account, e.g., registration02@samsung.com which is generated when subscribing to the Samsung company. In this case, the registered information may be synchronized with the payment server, based on the generated account.

In an embodiment, membership information generated by a barcode interface may be used to register cards, e.g., a first card (e.g., Samsung points card), a second card (e.g., CJ membership points card), etc., based on an account, e.g., registration01@samsung.com which is generated when subscribing to the Samsung company. In this case, the registered information may be synchronized with the payment server, based on the generated account.

The card user logs in via the payment application 630, determines whether the state of a card is active or inactive, based on the account, and enables the account management module to transmit the determined card state to the payment server. Alternatively, the user may manage the state of an account-based card on a server management web page (e.g., server portal), e.g., changing the state of a card.

The account management module is capable of managing membership information (e.g., CJ membership points, registraion001@Cj.com, etc.) and information regarding a card (e.g., Visa card ID & V) related to a service account (e.g., registration01@samsung.com), cooperating with a server. The membership information may be automatically updated in such a way that, when a card makes a payment, payment result information (e.g., payment price) and membership accumulation information (e.g., points, mileage, etc.) is automatically accumulated or balanced

When a payment application including an account management module is installed to an electronic device, it allows the user: to manage and use part or all of setting states of registered cards after logging in or signing in only once via the electronic device, regardless of the types of electronic device; and also to cooperate the setting states with the electronic device. In addition, membership information with a relatively low level of authentication security may be registered based on a user's account or cooperate with a user's account, thereby removing an additional authentication process.

In an embodiment, the authentication module 635 is capable of displaying a UI for authenticating a user or a payment card on the display 160. The authentication module 635 is capable of including a biometric module.

In an embodiment, the biometric module is capable of obtaining a user's biometric information, e.g., fingerprint, iris, facial feature, voice, heartbeat, blood pressure, etc. The electronic device is capable of obtaining a user's biometric information via a sensor module (e.g., sensor module 240I), e.g., fingerprint by a fingerprint sensor. The electronic device is capable of obtaining a user's iris information via a camera module. The biometric module is capable of displaying a UI for obtaining a user's biometric information on the display 160.

In an embodiment, when a user attempts to make a payment using card information registered in the electronic device, the biometric module performs authentication to obtain security data (e.g., token) from a security memory functionally connected to the electronic device (e.g., a built-in security element (eSE) or an accessible memory in a security environment). In order to perform user authentication, the electronic device is capable of obtaining a user's biometric information (e.g., fingerprint, iris, etc.) via the biometric module. The obtained biometric information is transmitted to a biometric management module 643 of the payment manager 640. In an embodiment, a security memory may be a memory capable of storing data with an encrypted key.

In an embodiment, when a user performs an electronic payment on the Internet webpage, the biometric management module 643 is capable of making a payment using the biometric information and the card information, registered in the electronic device. The biometric management module 643 performs authentication to obtain security data (e.g., token) from a memory or a security module (e.g., an eSE or a memory accessible in a security environment) functionally connected to the electronic device. When the user authentication is successfully progressing in the electronic device, the electronic device may proceed with fast automatic authentication, e.g., fast identity online (FIDO), where it cooperates with an external server and does not perform an additional electronic payment process on the Internet webpage. That is, the electronic device is capable of performing authentication required for online payment at high speed, i.e., fast authentication, cooperating with the biometric module.

In an embodiment, the electronic device is capable of previously designating (registering) a user's fingerprint or a card to make a payment. For example, when a user performs authentication with fingerprints using a payment application, he/she may have designated the right hand's thumb and index finger for a Visa card and a Master card, respectively. Therefore, the card can be used to make a payment when the user's fingerprint is authenticated.

In an embodiment, the device management module 637 is capable of managing an external device functionally connected to the electronic device. The device management module 637 is capable of including, e.g., an MST device module (not shown) and a wearable device module (not shown).

In an embodiment, the MST device module is capable of providing UI for outputting a wired/wireless connection state between an MST accessory (e.g., LoopPay™ fob) and the electronic device so that the user can perform corresponding operations. When the MST accessory is connected to the electronic device, the UI allows the user to perform card registration, card information deletion, or payment and outputs the results. When the MST accessory is connected to the electronic device, the MST device module is capable of storing card information required for payment in a separate memory in the MST accessory or the electronic device. In this case, although the MST accessory and the electronic device are not connected to each other, the electronic device or MST accessory can independently perform a payment process with the stored card information.

The wearable device module is capable of providing UI for outputting a wired/wireless connection state between a wearable device (e.g., watch, headsets, glasses, finger ring, etc.) and the electronic device so that the user can perform corresponding operations. Wired/wireless connection may be implemented with various types of interface such as BT, BT low energy (BLE), WiFi, Zigbee, Z-wave, etc. Alternatively, wired/wireless connection may be implemented with a specific accessory protocol, e.g., Samsung accessory protocol (SAP). When the wearable device is connected to the electronic device, the UI allows the user to perform card registration, card information deletion, or payment and outputs the results. In the process of card registration, card information deletion, or payment, the wearable device module is capable of: outputting a condition as to whether to generate a short-range-based secure session with respect to the wearable device; transmitting/receiving use inputs applied to the electronic device or the wearable device; and displaying the user inputs on the electronic device or the wearable device. Examples of the user inputs are card information required for payment, and added authentication information other than the card information, (e.g., a personal identification number (PIN), a user's unique pattern-related data, fingerprint recognition-related data, a wearable device bezel, a touch value input to the display 160, etc.).

In an embodiment, the electronic device is capable of sharing the same payment information (a single piece of information) with the wearable device or the accessory. For example, the information regarding a single Visa card is stored in both the wearable device and the electronic device. In an embodiment, when another piece of card information is further generated from the same card (a single card), the electronic device is capable of storing the other piece of card information in the wearable device and/or the accessory. For example, when two tokens are issued from a single Visa card (the same Visa card), the electronic device is capable of storing one token therein and the other token in the accessory and/or the wearable device. In a state where the electronic device stores one of the two tokens issued from the same card (a single card) therein and the other token in the accessory and/or the wearable device, when a payment module in one of the devices is activated, a payment module in the other device is inactivated. For example, in a state where one of the two tokens issued from the same Visa card (a single Visa card) is stored in an electronic device and the other token is stored in the accessory or the wearable device, when the wearable device makes a payment, the payment module in the electronic device may be inactivated. Alternatively, when the electronic device makes a payment, the payment module in the wearable device may be inactivated.

In an embodiment, the payment manager 640 is capable of including a payment relay module 641, a biometric management module 643, and a security environment relay module 646. In an embodiment, the payment relay module 641 is capable of relaying information regarding a card or information corresponding to a card (e.g., token) to a payment application, a kernel, or a payment server. The payment relay module 641 is capable of performing an offline payment via a communication module (e.g., an NFC module, an MST module, etc.). In NFC payment, the NFC module may be operated by a POS terminal (reader). In MST payment, the MST module may be operated by a user's input. The payment relay module 641 is capable of performing an online payment via a communication module (e.g., a cellular module, an RF module, a WI-FI module, etc.).

In an embodiment, the payment relay module 641 is capable of performing state management of information regarding a card or information corresponding to a card (e.g., token), i.e., management of card/token lifecycle. The payment relay module 641 is capable of providing the payment application 630 with at least one API related to payment.

In an embodiment, the payment relay module 641 may further include system service interfaces for providing a security UI for inputting a PIN or primary account number (PAN), a payment service for access to a payment module, TrustZone-based integrity measurement architecture (TIMA) for authenticating kernel integrity, a reference to a fingerprint recognition result (e.g., supporting both of security mode and non-security mode), an interface provided by at least one payment-related system services, etc. The payment relay module 641 is capable of including encryption libraries in order to transmit messages or commands to the TEE 620. The payment relay module 641 is capable of exchanging messages or commands with the TEE 620 via the encryption library.

In an embodiment, the payment relay module 641 is capable of including a card management function configured to provide general card management functions such as card addition, card information deletion, update, etc. The payment relay module 641 is capable of including a first payment SDK or a second payment SDK. The first payment SDK (e.g., Samsung SDK) may be embedded in the electronic device. The second payment SDK may be provided by a card issuing company or a bank and installed to an electronic device. The payment relay module 641 is capable of selecting a first or second payment SDK according to card information. Alternatively, the payment relay module 641 may set a payment card as a default card or additionally other cards for payment.

In an embodiment, the payment relay module 641 is capable of transmitting, to a payment server, messages related to general token and key management functions, such as token provisioning, token replenishment, token suspension, token resume, token disposal, etc.

In an embodiment, the payment module 621 is capable of obtaining a token and token cryptogram from an electronic device or an external electronic device. Keys for generating the token and token cryptogram, e.g., a limited used key (LUK) or a single used key (SUK), may be stored in the REE 610 or TEE 620. In order to store the token and the keys in the REE 610, the payment module of the TEE 620 encrypts the token and the keys, using a key of the TEE 620 (e.g., a device root key (DRK)), and stores the encrypted result. When the electronic device makes a payment, the payment relay module 641 is capable of obtaining a token which is decrypted from the encrypted token by the payment module. When a key or token to generate the token cryptogram is stored in the TEE 620, the electronic device stores the key or token which is encrypted using a key of the TEE 620.

In an embodiment, the payment relay module 641 is capable of receiving a push message from a TSP and transmitting the received message to the payment application.

In an embodiment, in a state where a first payment SDK (provided from a card issuing company or a bank) provides its token management function, when the payment relay module 641 receives a token management function request, it may relay the received request to the second payment SDK. For example, when the payment relay module obtains a token or key via an SDK of a Visa card, it may transmit the token or key to the payment module of the TEE 620 via a Samsung SDK. In an embodiment, the payment relay module 641 is capable of including, in a payment framework, host card emulation (HCE) that enables virtual cards in the electronic device to be used for payment, using only software, without a separate hardware device (e.g., a security module or a secure element (SE)). The HCE enables a token and token cryptogram to be transmitted via a communication module (e.g., NFC), using a message specification related to a POS terminal (reader), e.g., application protocol data unit (APDU).

In an embodiment, the payment relay module 641 is capable of including a function for processing messages received from a POS terminal The POS related message processing function may include a function for managing payment data responding to the POS terminal When the first payment SDK is equipped with a function of processing a POS related message, the POS related message analysis function may further include a function for replaying the POS related message via the first payment SDK. In an embodiment, the payment relay module 641 is capable of including at least one database for storing the card data, token data, transaction data, etc.

In an embodiment, the payment relay module 641 is capable of selecting an NFC payment mode and/or an MST payment mode when making a payment. For example, the payment relay module 641 may perform a payment in: an NFC payment mode first and then MST payment mode; an MST payment mode first and then NFC payment mode; or both NFC and MST payment modes simultaneously. In an embodiment, when payment is performed by two communication modules one after another, this is a case where: when the payment relay module does not have a response from one communication module that has first performed a payment or when a preset period of time has elapsed since the payment by one communication module, payment is performed by another communication module.

In an embodiment, when the payment relay module 641 has token information and PAN information regarding a single card, payment may be performed using token information and/or PAN information. The payment relay module is capable of determining whether a POS terminal can perform a payment using a PAN or a token. For example, when the electronic device receives information that the POS can use for payment via BLE, the payment relay module is capable of detecting the received information. When the payment relay module ascertains, based on the detected information, that payment can be performed using a token, it performs a payment using the token. Alternatively, when the payment relay module ascertains that payment can be performed using a PAN, it performs a payment using the PAN.

In an embodiment, the payment relay module 641 is capable of further including an SDK provided by a payment network. The SDK may include a token management, a POS related message process, or a token/card database.

In an embodiment, the security environment relay module 646 is capable of further including a relay function that enables a payment application to access a biometric information driver module 651 or a security environment driver module 653 in order to use functions provided by a payment module 621 or a biometric module 625. The payment relay module 641 is capable of further including an encryption library in order to transmit messages or commands to the security environment relay module 646. The payment relay module 641 is capable of transmitting/receiving messages or commands to/from the security environment relay module 646 via the encryption library.

In various embodiments, the payment manager 640 is capable of further including a security environment relay module 646 which allows a payment application to use functions of a security identifier process module 623 of the TEE 620.

In an embodiment, the payment relay module 641 is capable of further including a function for relaying an authentication request to the security identifier process module 623 of the TEE 620 via a PIN of the payment application 630.

When fingerprint recognition is requested, a general application is capable of obtaining a success or failure of fingerprint recognition. A security payment application (payment trusted app) is capable of obtaining a security biometric result (e.g., a secure fingerprint result). The security biometric result may have a form which is created as a one-time random number and a success/failure are combined with each other and encrypted. The one-time random number may be encrypted by a hardware key of the TEE 620, e.g., a DRK.

In an embodiment, the payment relay module 641 is capable of transmitting a message commanding payment to the payment module 621 via a security environment driver module 653. The payment module 621 is capable of notifying the payment relay module 641 that an authentication process needs to be performed, via the security environment driver module 653. In order to perform an authentication process, the payment relay module 641 is capable of commanding the biometric sensor (e.g., biometric sensor 240I) to obtain biometric information via the biometric management module 643 and the biometric information driver module 651. In addition, the payment relay module 641 is capable of transmitting an authentication acknowledgement message to the biometric module 625 of the TEE 620 via the biometric management module 643 and the security environment driver module 653. The biometric sensor (e.g., biometric sensor 240I) is capable of obtaining the biometric module 625. The biometric module 625 compares a user's stored biometric information with the information obtained by the biometric sensor and determines the identity of user. When the biometric module 625 transmits the authentication result to the biometric management module 643 via the security environment driver module 653, based on the identified information, the biometric management module 643 transmits the authentication result to the payment relay module 641. It should be understood that the payment relay module 641 and the biometric management module 643 may be configured into a single module or separate individual modules.

In an embodiment, the payment relay module 641 is capable of performing authentication via an external device. For example, the electronic device may request authentication on biometric information (e.g., fingerprint, iris, etc.) from a payment server (e.g., Samsung account server or token requester server). The payment server performs authentication on a user's biometric information and transmits the authentication result to the electronic device. After the authentication has been completed, the payment relay module 641 transmits data containing authentication complete to the TSP, thereby performing a token provisioning process. When the authentication has been completed, the electronic device may perform a payment. On the other hand, when the authentication has not been completed or the authentication failed, the electronic device may not perform a payment.

In an embodiment, the kernel 650 is capable of including a biometric information driver module 651 and a security environment driver module 653. The biometric information driver module 651 is capable of transmitting messages received from the biometric management module 643, to the biometric sensor (e.g., biometric sensor 240I). The biometric information obtained by the biometric sensor may be transmitted to the biometric module 625 of the TEE 620, but not to a module of the REE 610, via the biometric information driver module 651.

In an embodiment, the security environment driver module 653 serves as an interface between modules of the REE 610 and modules of the TEE 620. For example, when the TEE 620 is ARM TrustZone, the AP runs operations in the REE 610 and TEE 620 in time-divisional manner. In this case, a data path may be implemented in hardware to transmit messages from the REE 610 to the TEE 620. In this case, a driver module to access hardware may be the security environment driver module 653. The security environment driver module 653 is capable of transmitting messages related to operations of the modules in the TEE 620 to the modules of the REE 610.

In an embodiment, the TEE 620 is capable of including a payment module 621, a security identifier process module 623, a biometric module 625, and an MST driver module 627. The electronic device is capable of storing data that needs a relatively high level of security in a safe environment via the TEE 620 and performing corresponding operations. The TEE 620 runs on an AP of the electronic device. A reliable TEE that is determined in the process of manufacturing electronic devices may refer to a secure world in the electronic devices. The electronic device may process data that needs a relatively high level of security via a TEE, based on the safe hardware architecture. The TEE may run an AP and a memory area in a normal world and a secure world. In addition, the TEE enables hardware or software that needs security to run in only a secure world. When the electronic device needs to perform operations related to information susceptible to the REE 610, it may access to the TEE 620 via only API and drivers which are capable of accessing the TEE 620. The TEE 620 may hand over data limited to related information to the REE 610. The TEE 620 is capable of encrypting internally stored data via a hardware key, e.g., a DRK. When data of the TEE 620 is not decoded, it may not be analyzed in the REE.

The application of the TEE 620 (e.g., trusted application, payment module, etc.) is capable of transmitting messages to an external electronic device (e.g., TSP).

In an embodiment, the TEE 620 is capable of including a trusted OS (not shown) and a trusted application (not shown). In addition, the TEE 620 is capable of further including a security-related encryption module (not shown), a driver (not shown) capable of collecting data from hardware that needs security, etc. The trusted application is capable of including a payment module. The trusted application is capable of transmitting payment information to the outside via the communication module. For example, the trusted application is capable of transmitting: payment information to an MST controller via an MST driver; or an NFC controller via an NFC driver, so that the controller can transmit the payment information to a POS terminal.

In an embodiment, the integrity on the REE 610 is checked. The electronic device is capable of storing the verification of the integrity of an image of the REE in the TEE 620. In the REE 610 booting process that supports the TEE 620, when the boot loader is executed according to the booting sequence, it boots the TEE 620 and then the REE. When the TEE 620 is booted, the boot loader detects the integrity of the REE 610 in the TEE 620 and then informs the user of the integrity after the REE 610 has been booted. In an embodiment, when the REE 610 is attacked by hacking or rooting and the image is damaged, the integrity on the image is also impaired. When the integrity on the image is impaired, access to the TEE 620 is blocked. For example, when the payment relay module 641 needs to transmit a message or command to the TEE 620 via the security environment driver module 653, the kernel of the TEE 620 may ignore the message or command or reject to receive the message.

In an embodiment, the payment module 621 may be an application installed by a bank, a card issuing company (e.g., Visa card, Master card, etc.), etc. The payment module may be configured with one or more payment modules. When an electronic device is attached to a payment server (e.g., a mobile application platform, a payment gateway, a token requestor, a TSP, a trusted service manager, a bank server, etc.) or a TSP, over the Internet, using the payment management module 631, and approves of the installation of the payment module 621, the TSP may perform operations related to the installation. For example, the payment management module 631 obtains a card number and expiration date of a plastic card via the OCR and performs a card registration operation to a server in order to install the payment module 621. When an electronic device: connects to the TSP in the network, via the payment relay module 641 that has connection information regarding individual TSPS according to cards/banks; and download the installation files from the provider, the payment relay module 641 transmits the information to the TEE 620 and installs the payment module 621 therein. This process is called a provisioning process or a card registration process. The payment module 621 of the TEE 620 may be configured with a number of payment modules. The individual payment modules may be configured in such a way that they do not exchange data with each other in the TEE 620 and are separated from each other.

In an embodiment, the payment module 621 may be an application to use for data communication with the payment server. The payment module may contain information regarding various types of cards, such as a credit card, a debit card, a membership card, etc. The payment module is capable of exchanging encrypted communication data with external electronic devices. The encryption process may vary depending on card manufacturing companies which transmit the payment module. The server is capable of controlling the status of the payment module. For example, the server is capable of performing the activation, suspension, resumption, or disposal of the payment module.

In an embodiment, the payment module 621 is capable of storing information related to card information. For example, the card information may be at least one of the following: a token corresponding to a PAN, a token reference ID, part of PAN, a PAN product ID, a token requestor ID, a token assurance level, token assurance data, an expiration date of token, an encryption key, and a value provided by a TSP (e.g., one-time password (OTP). A token may be controlled by conditions of the TSP. For example, a token may be activated, suspended, resumed, or disposed. A token may be static information corresponding to card information (e.g., PAN).

In an embodiment, when payment is performed, the payment module 621 may determine a card to make a payment. For example, one or more payment modules corresponding to one or more cards selected by the user may be determined in payment management modules 631. The payment management module is capable of transmitting information regarding the determined card to the payment relay module 641. The payment relay module 641 is capable of transmitting the determined card information to the payment module 621 via the security environment driver module 653. The payment module is capable of managing a list of cards which are actually used for payment, from the cards whose information is stored therein. The payment module is capable of changing the list of cards which are actually used for payment, based on the determined card information. Changing a list of cards may refer to a process of increasing the priority of the determined card in the card list or a process of deleting information regarding cards except for the determined card.

In an embodiment, when payment is performed, the payment module is capable of generating information to be used for payment, based on the information related to card information. The information to be used for payment may be a token, a token reference ID, part of PAN, a PAN product ID, a token requestor ID, a token assurance level, a token assurance data, an expiration date of token, a token cryptogram, a POS entry mode, a token requestor indicator, etc.

TABLE 3

| Field Name | Comment |
|---|---|
| Payment Token | The Payment Token number refers to a surrogate value for a PAN that |
| | is a 13 to 19-digit numeric value that passes basic validation rules of |
| | an account number, including the Luhn check digit. Payment Tokens |
| | are generated within a BIN range or Card range that has been |
| | designated as a Token BIN Range and flagged accordingly in all |
| | appropriate BIN tables. Payment Tokens are generated such that they |
| | will not have the same value as or conflict with a real PAN. |
| | Transaction messages |
| | The Payment Token number will be passed through the |
| | authorization, capture, clearing, and exception messages in lieu of the |
| | PAN. |
| | The Payment Token number may optionally be passed from the |
| | Token Service Provider to the Card Issuer as part of the authorization |
| | request. |
| Token Expiry Date | The expiration date of the Payment Token that is generated by and |
| | maintained in the Token Vault. The Token Expiry Date field carries a |
| | 4-digit numeric value that is consistent with the ISO 8583 format. |
| | Transaction messages |
| | The Token Expiry Date is passed in lieu of PAN Expiry Date. |
| | The value is replaced by the Token Service Provider with the PAN |
| | Expiry Date which is then passed to the Card Issuer as part of the |
| | authorization request. |
| Last 4 Digits of | The last four digits of the PAN to be provided optionally through the |
| PAN | Acquirer to the Merchant for customer service usage such as being |
| | printed on the consumer receipt. |
| PAN Product ID | The last four digits of the PAN to be provided optionally through the |
| | Acquirer to the Merchant for customer service usage such as being |
| | printed on the consumer receipt. |
| PAN Product ID | The PAN Product ID is an optional identifier used for determining the |
| | type of Card product that was tokenized. It may be included in cases |
| | where transparency of this information is necessary. |
| | Transaction messages |
| | The PAN Product ID may optionally be passed from the Token |
| | Service Provider to the Acquirer as part of the authorization response. |
| POS Entry Mode | This specification uses the POS Entry Mode field to indicate the mode |
| | through which the Payment Token is presented for payment. Each |
| | Payment Network will define and publish any new POS Entry Mode |
| | values as part of its existing message specifications and customer |
| | notification procedures. |
| | Transaction messages |
| | POS Entry Mode is an existing field that will be passed through the |
| | authorization, capture, clearing, and exception messages. |
| Token Requestor | This value uniquely identifies the pairing of Token Requestor with the |
| ID | Token Domain. Thus, if a given Token Requestor needs Tokens for |
| | multiple domains, it will have multiple Token Requestor IDs, one for |
| | each domain. It is an 11-digit numeric value assigned by the Token |
| | Service Provider and is unique within the Token Vault: |
| | Positions 1-3: Token Service Provider Code, unique to each Token |
| | Service Provider |
| | Positions 4-11: Assigned by the Token Service Provider for each |
| | requesting entity and Token Domain |
| | Transaction messages |
| | Token Requestor ID can be optionally passed through the |
| | authorization, capture, clearing, and exception messages. |
| Token Assurance | Token Assurance Level is a value that allows the Token Service |
| Level | Provider to indicate the confidence level of the Payment Token to |
| | PAN/Cardholder binding. It is determined as a result of the type of |
| | ID&V performed and the entity that performed it. |
| | The Token Assurance Level is set when issuing a Payment Token and |
| | may be updated if additional ID&V is performed. It is a two-digit |
| | value ranging from 00 which indicates the Payment Token has no |
| | ID&V that has been performed to a value of 99 indicating the highest |
| | possible assurance. The specific method to produce the value is |
| | defined by the Token Service Provider. |
| | Transaction messages |
| | Token Assurance Level will be provided by the Token Service |
| | Provider. |
| | The value may be optionally passed to the Card Issuer as part of the |
| | authorization request. |
| | The value may optionally be passed to the Acquirer/Merchant in |
| | the authorization response, capture, clearing, and exception |
| | processing messages. |
| Token Assurance | This data provided by the Token Service Provider contains supporting |
| Data | information for the Token Assurance Level. |
| | Transaction messages |
| | This data may be optionally passed to the Card Issuer as part of the |
| | authorization request. |
| Token Cryptogram | This cryptogram is uniquely generated by the Token Requestor to |
| | validate authorized use of the Token. The cryptogram will be carried |
| | in different fields in the transaction message based on the type of |
| | transaction and associated use case: |
| | NFC contactless transactions will carry the Token Cryptogram in |
| | existing chip data fields. |
| | Other transactions, such as those originating from a digital wallet, |
| | may carry the Token Cryptogram in an existing field. |
| | Transaction messages |
| | The Token Cryptogram will be passed in the authorization request and |
| | validated by the Token Service Provider and/or the Card Issuer. |
| Token Request | An indicator used to indicate that the message is intended to |
| Indicator | authenticate the Cardholder during a Payment Token Request. |

In an embodiment, the payment module 621 is capable of receiving a key (e.g., LUK or SUK) which is used to generate a token cryptogram by a TSP or a payment server (e.g., a payment service server or a token requester server). The payment module 621 is capable of receiving the key via a data network, SMS, etc.

The electronic device and the TSP exchange the key with each other via a security channel The security channel may be a logical channel through which data, encrypted by another key (e.g., a public key, a private key) that differs from the key, is transmitted. In addition, the payment module is capable of further including a module for generating a key used to generate a token cryptogram. The electronic device is capable of receiving the module for generating the key, via the TSP or the payment server. Alternatively, the module for generating the key may be embedded into electronic devices in the process of manufacturing the electronic devices.

In an embodiment, the payment module is capable of generating a token cryptogram by using a key (e.g., LUK or SUK) which is used to generate a token cryptogram. The payment module may use different keys according to preset rules, such as each transaction, a transaction of a certain number of times, transaction within a period of time, etc. The TSP has keys which form a pair with the key described above. The TSP is capable of decrypting the encrypted token cryptogram using the keys forming a pair.

In an embodiment, the payment module 621 is capable of generating a token cryptogram using a key which is used to create a token cryptogram.

In an embodiment, when the electronic device performs a payment, the payment application transmits a message indicating that it is going to make a payment to the payment relay module 641. The payment relay module 641 determines whether it makes a payment in an MST mode or NFC mode. When the payment relay module 641 ascertains that it makes a payment in an MST mode, it obtains information required for payment (e.g., a token, a token cryptogram, part of PAN, an expiration date of token, etc.) from the payment module of the TEE 620 and transmits the obtained information to the MST driver module 627 in the TEE 620. The MST driver module 627 transmits the received information to the MST controller (not shown). The MST controller is capable of transmitting the information in order to perform a payment.

In an embodiment, when the payment relay module 641 ascertains that it makes a payment in an NFC mode, it transmits information required for payment to the NFC driver module of the TEE 620. The NFC driver module transmits the received information to the NFC controller. The NFC controller performs a payment based on the received information.

In an embodiment, when the electronic device performs a payment in an NFC mode, it receives, a POS terminal, a message designated the POS terminal and then makes a payment. For example, when the NFC module detects a message designated a POS terminal, the NFC controller transmits the message to the NFC driver module. The NFC driver module transmits a signal indicating that the message is transmitted from a POS to the payment relay module 641 of the REE. The payment relay module 641 generates a token cryptogram to make a payment. The payment module 621 generates the token cryptogram using a key (e.g., LUK or SUK) which is used to generate a token cryptogram. The generated token cryptogram is transmitted to the REE. The payment relay module 641 transmits payment-related information containing the token cryptogram and the token to a network module (e.g., NFC related HSE module). The network module transmits the payment-related information to the POS terminal via the NFC module.

In an embodiment, the payment module is capable of transmitting, to an electronic device, information containing the token, an expiration date of token, a token requestor ID, a token cryptogram, etc. For example, the payment module is capable of transmitting the payment information to the POS terminal via the MST communication module. Alternatively, the payment module is also capable of transmitting the payment information to the POS terminal via the NFC communication module.

In an embodiment, the payment module is capable of transmitting/receiving information designated for payment to/from a POS terminal In case of payment in NFC mode, the POS first receives the designated information from the payment module and then performs a payment. In case of payment in MST mode, the payment module transmits/receives payment-related information containing a token cryptogram and a token to/from the POS, according to a user's explicit input or based on an algorithm of the electronic device.

In an embodiment, the biometric module 625 is capable of storing an electronic device user's biometric information and comparing the stored biometric information with information detected by the biometric sensor to authenticate the user. Examples of the biometric module 625 are a fingerprint information module, an iris information module, etc. The biometric module is capable of collecting information via a biometric sensor (e.g., a biometric sensor 240I). When the payment application shows a message requesting to authenticate a user's biometric information on the display 160, the user may input his/her biometric information to the biometric sensor. The authentication module of the payment application enables the biometric management module to transmit a message commanding to collect biometric information to the biometric information driver module 651. The biometric information driver module 651 transmits the received message to the biometric sensor. The biometric sensor collects biometric information and transmits the collected information to the TEE 620. The biometric module 625 of the TEE 620 compares a user's stored biometric information with the collected biometric information, and transmits the authentication result to the authentication module 635 of the payment application 630 in the REE, via the security environment driver module 653 and the biometric management module 643 in the REE. The payment application shows the authentication result on the display. The user's biometric information may be stored: in the TEE 620; in an encrypted format in the REE; or in a security module 236 (e.g., an eSE).

In an embodiment, the security identifier process module 623 obtains an input value, required by the electronic device or related to authentication for payment, from a user's inputs. For example, the input value may be a PIN used when payment is performed. The input value may also be card-related information, e.g., a PAN, an expiration date, a card verification value (CVV), a Chip PIN, ATM PIN, etc. The security identifier process module 623 may be displayed as in a form of application. TEE 620 may store a graphic library required to show the application of the security identifier process module on the screen. The graphic library stored in the TEE 620 may differ from that stored in the REE 610. The security identifier process module authenticates a user according to a user's PIN, etc., and transmits the authentication result to the payment management module 631 via the payment relay module 641. In an embodiment, the security environment relay module 646 is capable of receiving an encrypted one-time random number (e.g., nonce) from the security environment driver module 653. The security identifier process module 623 encrypts the one-time random number and the input value obtained according to a user's input, using an encryption key of the TEE 620 (e.g., (DRK)), and transmits the encrypted result to the security environment relay module 646. The security environment relay module 646 is capable of transmitting the encrypted, one-time random number and the encrypted, input value to the payment module 621 via the security environment driver module 653. The payment module 621 is capable of decrypting the encrypted, one-time random number and the encrypted, input value, using a hardware key of the TEE 620. When the payment module 621 ascertains that the received value is identical to the created value of the one-time random number, it ascertains that the input value transmitted via the REE 610 has the integrity. The payment module is capable of performing user authentication, using the input value which is of integrity. The payment module performs a payment based on the result of user authentication. In an embodiment, a factory reset refers to a process for restoring a software image of an electronic device to its original manufacturing settings. The factory reset may be performed in an electronic device as the electronic device user executes a corresponding application. Alternatively, in a state where an electronic device is equipped with a module for monitoring a hacking attack, when the module ascertains that the electronic device has a hacking attack based on a preset condition (e.g., a condition to determine whether a system has a hacking attack), it may perform the factory reset in the electronic device. When the factory reset is performed, data stored on the electronic device is reset or restored to its original system state, and thus a user's payment-related information may also be erased. The payment-related information may be stored in the payment server. When the user logs in the payment server with his/her account, he/she needs to perform registration of cards and installation of payment modules, again, based on the payment-related information. When a factory reset is performed in an electronic device, the payment-related module stored in the electronic device is inactivated in the TSP by the payment server. When a network of the electronic device is inactivated, the notification process may not be performed. In this case, the electronic device performs a factory reset and accesses to the payment server based on an account. The electronic device is capable of ascertaining a list of registered cards via the payment server, and inactivating a token or card module of the electronic device, registered in the TSP, via the payment server. The electronic device is capable of performing card registration and receiving a token or a payment module, again, based on a card list of the payment server.

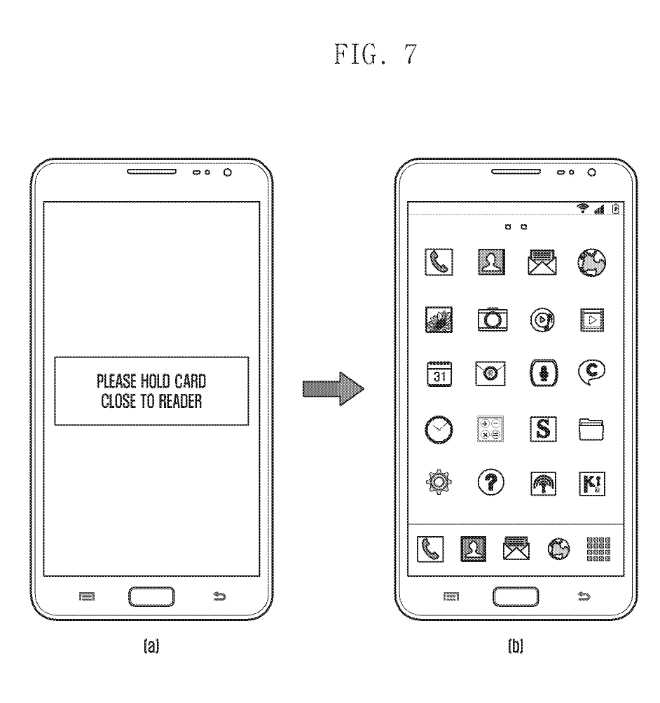

FIG. 7 illustrates a payment user interface UI of an electronic device according to various embodiments of the present disclosure. In the embodiment, the payment UI is displayed when a payment application is activated and a lock function is not selected.

Referring to diagram [a] in FIG. 7, the electronic device (e.g., electronic device 101) is capable of performing a payment or a transaction using a payment application. For example, the user may execute a payment function using a payment application in the electronic device and obtains information related to the payment function.

Referring to diagram [2] in FIG. 7, when the electronic device executes a payment application, it means that the electronic device is unlocked. When the electronic device recognizes an event for pressing a button (e.g., a home button) during the payment, it enters a mode for showing a normal screen (e.g., a home screen). When an electronic device user hands over his/her electronic device to another person in order to make a payment, the other person may access other functions unrelated to a payment application. In this case, an invasion of privacy or a leakage of security-related information may arise.

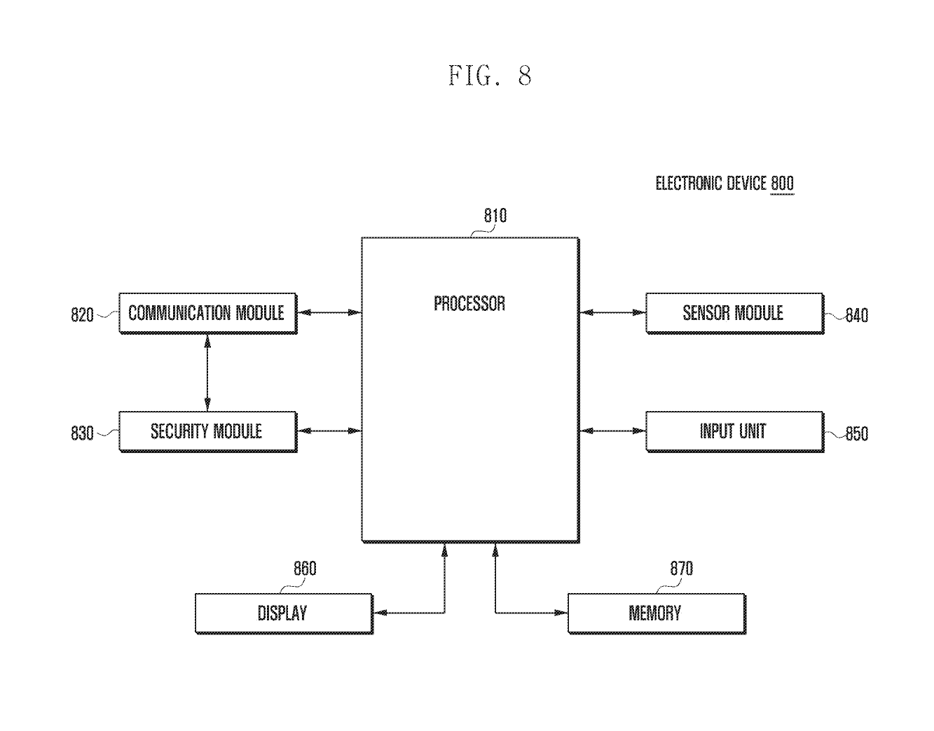

FIG. 8 is a block diagram illustrating a hardware configuration of an electronic device 800 according to various embodiments of the present disclosure.

Referring to FIG. 8, the electronic device 800 is capable of including a processor 810, a communication module 820, a security module 830, a sensor module 840, an input unit 850, a display 860 and a memory 870. It should be understood that the components included in the electronic device 800 are not limited to the embodiment shown in FIG. 8. For example, the electronic device 800 may be modified in such a way that part of the components is removed or replaced with other elements equivalent thereto.

In various embodiments, when a payment mode is activated in the electronic device, the processor 810 may limit access to resources unrelated to payment. For example, when a button (e.g., a home button) is applied to the electronic device during the payment, the processor 810 may not switch the payment screen to a normal screen (e.g., a home screen).

In various embodiments, the processor 810 is capable of controlling the display 860 to display a first UI related to payment. The processor 810 is capable of limiting switching from the first UI to a second UI, unrelated to payment, during the payment. For example, the first UI may include a payment screen of a payment application. The second UI may include a home screen.

In various embodiments, the processor 810 is capable of controlling the communication module 820 (e.g., NFC module, MST module, or BT module) to transmit payment information to an external device, e.g., a POS terminal (reader). The payment information may be preset payment conditions. Examples of the payment conditions are: information that the electronic device received from an external device based on a payment-related policy; an available time to make a payment, set to the payment application; location information regarding the electronic device; a payment limit set to the payment application; or a combination thereof.

In various embodiments, the processor 810 is capable of controlling the security module 830 to obtain card information related to payment. The processor 810 is capable of controlling the communication module 820 to transmit/receive the card information to/from an external electronic device, e.g., an electronic device 102 or 104 or a server 106.

In various embodiments, in order to perform user authentication, the input unit 850 may be implemented to include a general input unit for receiving a PIN, and a biometric sensor for receiving biometric information such as fingerprint, e.g., a biometric sensor 240I, a sensor module 240 or 840, etc. For example, the input unit 850 may obtain a user's biometric information (e.g., fingerprint) via the biometric sensor (e.g., a biometric sensor 240I) and use the obtained biometric information as a payment authentication means.

In various embodiments, the memory 870 is capable of storing information regarding a number of resources, including a first resource unrelated to payment or a second resource related to payment.

In various embodiments, the electronic device includes: a memory configured to store information regarding a number of resources and information regarding a second resource related to payment; a communication module configured to transmit or receive payment information to or from an external device; a display for displaying a UI; and a controller for: activating a payment application for making a payment; limiting access to a first resource unrelated to payment, based on the activated payment application; and performing at least a part of the functions related to payment, using the second resource related to payment, while limiting access to the first resource.

In various embodiments, the payment application is activated, based on a manual input by a user, an automatic input by an occurrence of a preset event or a combination of the manual input and the automatic input.

In various embodiments, the preset event of the electronic device may occur based on the motion of the electronic device, security information set to the electronic device, location information regarding the electronic device, information obtained by a number of sensors of the electronic device, instructions received from an external electronic device, or a combination thereof.

In various embodiments, at least a part of the payment related functions of the electronic device is performed based on a preset payment condition.

In various embodiments, the payment condition includes: information received from an external device based on payment-related policy, time to perform payment, set to the payment application, location information regarding the electronic device, a payment limit set to the payment application, or a combination thereof.

In various embodiments, the payment condition is set to the electronic device, based on a user input.

In various embodiments, the processor: controls the display to display a first UI related to the payment execution; and limits switching from the first UI to the second UI unrelated to payment, during the payment execution.

In various embodiments, the electronic device may further include: a security module for obtaining information regarding a card related to the payment. The processor controls the communication module to transmit or receive the obtained card information to or from an external electronic device.

In various embodiments, the processor activates a handover mode and limits access to the first resource unrelated to payment, based on the activation of a handover mode.

In various embodiments, the handover mode of the electronic device is activated, based on an input selecting a handover mode, an input PIN, a payment user's unique pattern, biometric information of a payment user, or a combination thereof.

In various embodiments, the processor receives an input for releasing the limitation of access to the first resource.

In various embodiments, the processor receives the input for releasing the limitation of access to the first resource and returns back to a state before the payment application is activated.

In various embodiments, the input for releasing the limitation of access to the first resource comprises at least one of the following: a PIN, a payment user's unique pattern, biometric information of a payment user, or a combination thereof.

In various embodiments, the processor receives: an input for authenticating a payment user; and an input for releasing the limitation of access to the first resource. The input for releasing the limitation of access to the first resource includes an input that differs from an input for authenticating the payment user, an OTP or a combination thereof.

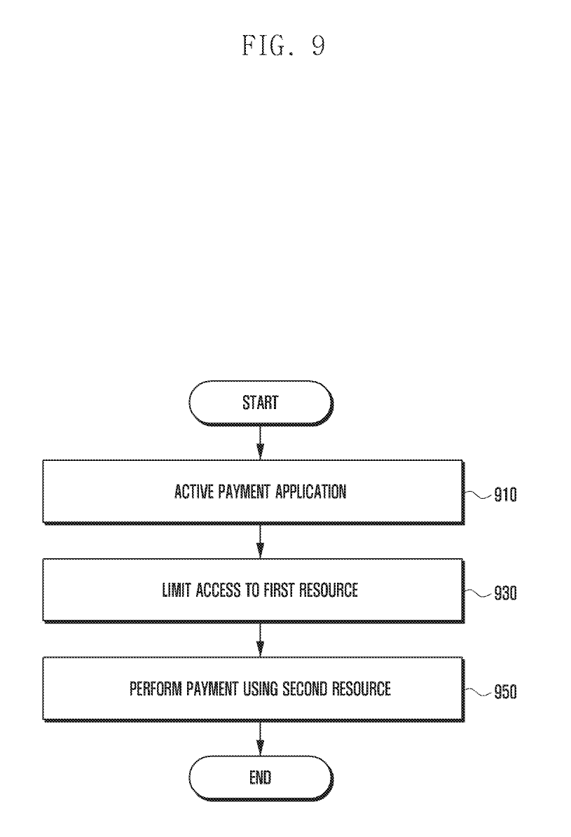

FIG. 9 is a flow diagram that describes a secure payment method according to various embodiments of the present disclosure. Although the secure payment method according to the present disclosure is described based on an embodiment using the electronic device 800, it should be understood that the present disclosure is not limited to the embodiment.

Referring to FIG. 9, the processor 810 of the electronic device 800 activates an application to perform a payment in operation 910.

In various embodiments, the payment application may be activated according to a manual input by a user, an automatic input by an occurrence of a preset event, or a combination of the manual input and the automatic input.

Examples of the manual input are a touch input, a gesture input, a proximity input, a hovering input, etc. by a users' body or a tool such as a stylus pen. The manual input may be applied to the electronic device via a sensor module. For example, in a state where a payment application has been set to be activated by a user's operation via a gesture sensor or a biometric sensor, when the processor 810 recognizes the user's operation, it activates the payment application.

Examples of the automatic input by an occurrence of a preset event are the motion of the electronic device 800, security information set to the electronic device 800, location information regarding the electronic device 800, information obtained by a number of sensors of the electronic device 800, instructions received from an external electronic device, or a combination thereof. For example, when at least one of the present events occurs, the electronic device 800 detects the event and activates a payment application.

The security information regarding the electronic device 800 may be information based on: an access control policy which classifies all the processes and applications stored in a system into domains and sets individual accessible domains; or an access control policy which is distributed from a mobile device management (MDM) server or a 3^{rd} party server. When a preset event occurs according to the access control policy, the payment application may be activated in the electronic device.

The information obtained by a number of sensors of the electronic device 800 may be a user's voice obtained via a microphone (e.g., a microphone 288), illuminance information obtained by an illuminance sensor (e.g., an illuminance sensor 240K), information regarding an access point or a base station connected to the electronic device, obtained via the communication module (e.g., communication module 220), etc. When the information obtained by sensors corresponds to a preset value, the payment application may be activated in the electronic device.

In should be understood that the inputs for activating the payment application are not limited to the embodiment described above. The inputs for activating a payment mode may be set via various types of sensors or input units.

The processor 810, in operation 930, is capable of limiting access to a first resource unrelated to payment, based on the activation of payment application, in operation 910.

The resource may include hardware functionally connected to the electronic device 800, software running via hardware, commands executed by the processor 810 of the electronic device 800, or a combination thereof. The electronic device 800 may provide a number of resources and storing information regarding resources related to payment and resources unrelated to payment, distinguished from each other. Various access control policies may be established based on the stored information regarding resources.

In various embodiments, the first resource unrelated to payment may include application (e.g., SMS/MMS, browser, etc.), hardware (e.g., a gyro sensor, an acceleration sensor, etc.), processes, and commands, which are not allowed for access when payment is performed, according to an access control policy.

In various embodiments, limiting access to the first resource may be performed by a corresponding user input applied to the electronic device 800. For example, the second resource related to payment may be so that a user input is not allowed for access thereto. Alternatively, the second resource related to payment may be so that a user input is allowed for access thereto.

In various embodiments, limiting access to a first resource refers to a process for ending an application or a process unrelated to payment, which is currently activated, a process for disenabling hardware (e.g., an acceleration sensor or a microphone, etc.), and a process for limiting an attempt to use a resource related to payment for a use or channel unrelated to payment.

In a state where access to a first resource is limited, the processor 810 is capable of performing at least a part of the payment execution using a second resource related to payment in operation 950.

In various embodiments, the processor 810 controls the display 860 to display a first UI related to payment execution. While payment is performed, the processor 810 limits switching from the first UI to the second UI unrelated to payment execution in operation 950.

In various embodiments, the second resource related to payment execution may include application (e.g., a payment application, etc.), hardware (e.g., a biometric sensor, a communication module, etc.), processes, and commands, which are allowed for access when payment is performed, according to an access control policy.

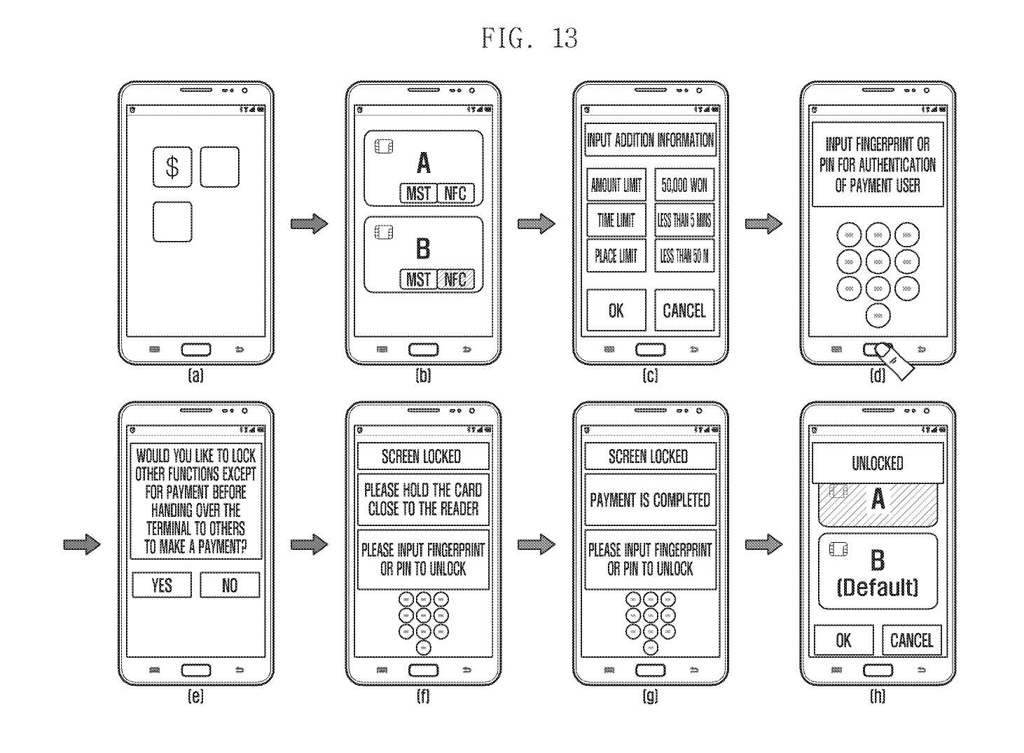

In various embodiments, the processor 810 is capable of performing at least a part of the payment-related functions based on preset payment conditions in operation 950. Examples of the payment conditions are: information that the electronic device received from an external device, based on a payment-related policy; an available time to make a payment, set to the payment application; location information regarding the electronic device; a payment limit set to the payment application; or a combination thereof. The information that the electronic device received from an external device, based on a payment-related policy, may be commands or conditions received from an electronic device (e.g., an electronic device 102 or 104 or a server 106) according to an access control policy. The embodiments using the preset payment conditions are described in detail layer referring to FIGS. 13, 14 and 15.

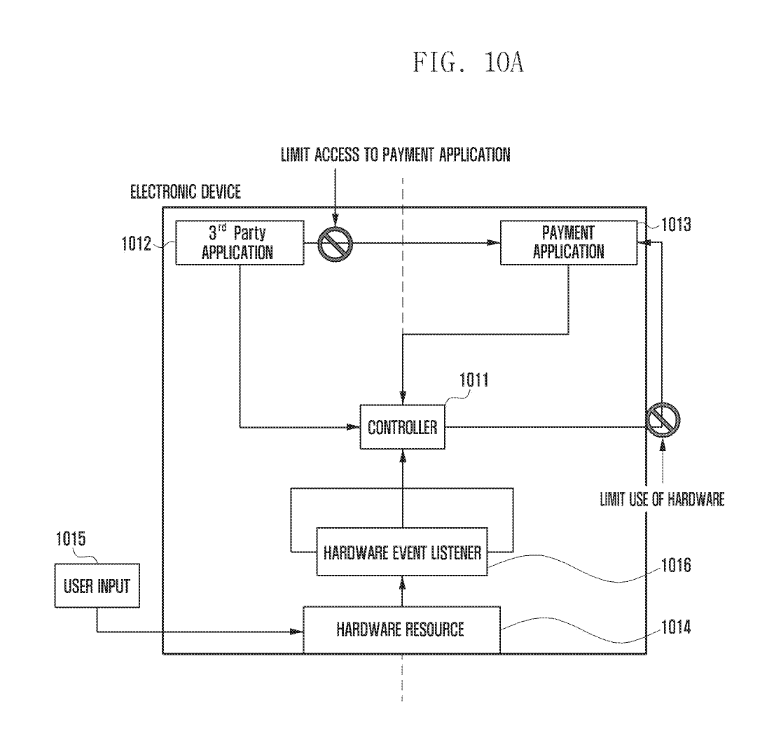

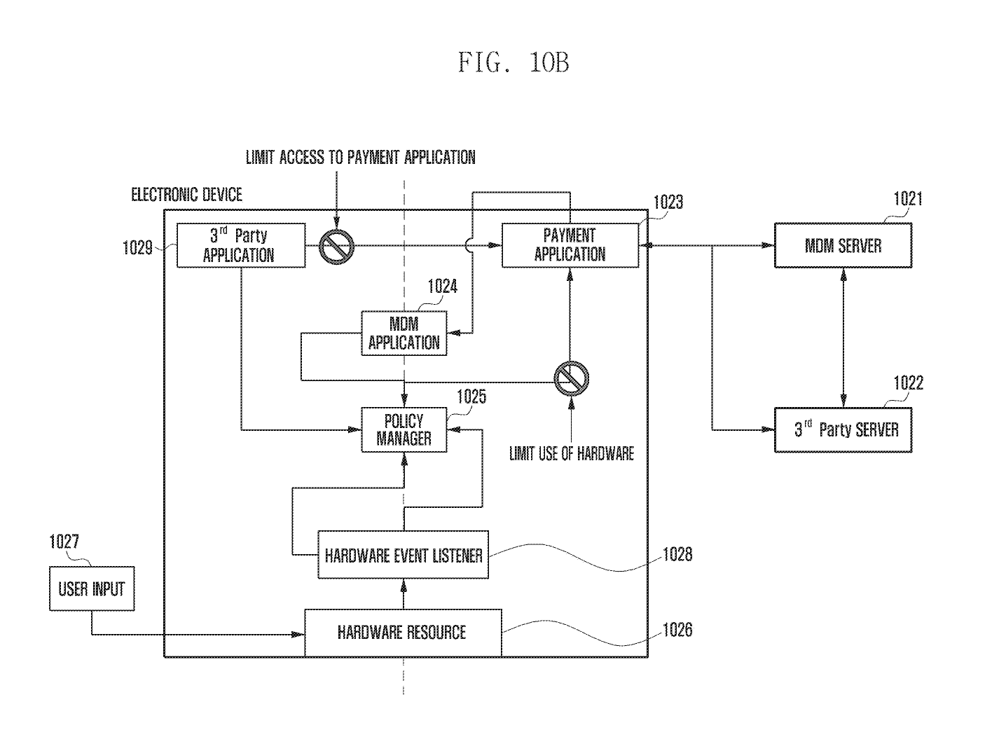

FIGS. 10A and 10B illustrate methods of limiting access to a first resource, using a mandatory access control (MAC) solution or an MDM solution, according to various embodiments of the present disclosure.

Referring to FIGS. 10A and 10B, a MDM solution is a method of classifying all processes and applications on a system into domains, setting individual accessible areas, and regulating the authority. In various embodiments, the MAC solution allows accessible subjects to be limitedly defined based on an access control policy and to be applied to information to be protected, thereby blocking: a user who does not have authority; or the access of malicious code.

An MDM solution refers to a series of processes for protecting, administering, monitoring and supporting mobile devices such as smartphones, tablet PCs, portable computers, etc. More specifically, an MDM solution refers to the setup of a safe password, a mobile application distribution, a process of remotely deleting data when mobile devices are stolen or lost, etc. In various embodiments, the MDM solution allows for the definition and distribution of an access control policy, thereby blocking: a user who does not have authority; or the access of malicious code.

The access control policy may be a Minimum Privilege Policy or Maximum Privilege Policy. The Minimum Privilege Policy refers to a policy based on a need-to-know security. The Maximum Privilege Policy refers to a polity based on a maximum availability principle. For example, the access control policy may be: an Identity-Based access control policy that limits access to an object based on a status of a group or a subject; a Rule-Based access control policy that limits access to an object based on a subject's accessible authority with respect to access information and an allowable ranking of information contained in an object; or a role-based access control (RBAC) policy of an administrator regulating a relationship between a subject and an object and determining whether to allow for access to resources based on roles within an organization. Since the access control policies are well known to those who skilled person in the art, a detailed description is described in this disclosure.

Referring to FIG. 10A, the controller 1011 (e.g., processor 810) stores an access control policy for classifying all processes and applications on a system into domains and setting individual accessible areas. The controller 1011 limits access of a 3^{rd} party application 1012 to a payment application 1013, based on an access control policy. When a hardware event listener 1016 recognizes a user input 1015 for a hardware resource 1014, the controller 1011 may limit the use of hardware based on the access control policy. The controller 1011 stores the entire authority for objects used according to domains in an access control policy. When the controller 1011 detects an access without authority, it may limit the access. As such, the controller 1011 limits access to a first resource (e.g., hardware resource 1014).

Referring to FIG. 10B, an MDM server 1021 or 3^{rd} party server 1022 is capable of distributing an access control policy to the MDM application 1024 via the payment application 1023. The policy manager 1025 may limit access of the 3rd party application 1029 to the payment application 1023, based on the access control policy distributed to the MDM application 1024. The access control policy is received from an external electronic device (e.g., electronic device 102 or 104 or a server 106) and stored in the electronic device. When a hardware event listener 1028 recognizes a user input 1027 to a hardware resource 1026, the policy manager 1025 may limit the use of hardware based on an access control policy. As such, the controller 1011 limits access to a first resource (e.g., hardware resource 1026).

In various embodiments, the processor 810 is capable of determining a payment-related object, based on data transmitted from an external device or a file recording a payment-related process. The processor 810 is capable of detecting whether an object other than the determined payment-related object attempts to access a payment-related object. When the processor 810 ascertains that an object attempts to access a payment-related object, it is capable of blocking the access path of the object. The path blocked refers to a general concept including commands, API, etc. that objects, not classified as a payment-related object, use for access to the TrustZone.

In various embodiments, the processor 810 is capable of determining a payment-related object, based on data transmitted from an external device or a file recording a payment-related process, and detecting whether a payment application and a handover mode is activated. When a payment application or handover mode is activated, the processor 810 is capable of blocking a path running operations other than a payment-related process. The path is used in the sense of a general concept including access to hardware resources, such as a home button, a camera, a power button, a microphone, etc.

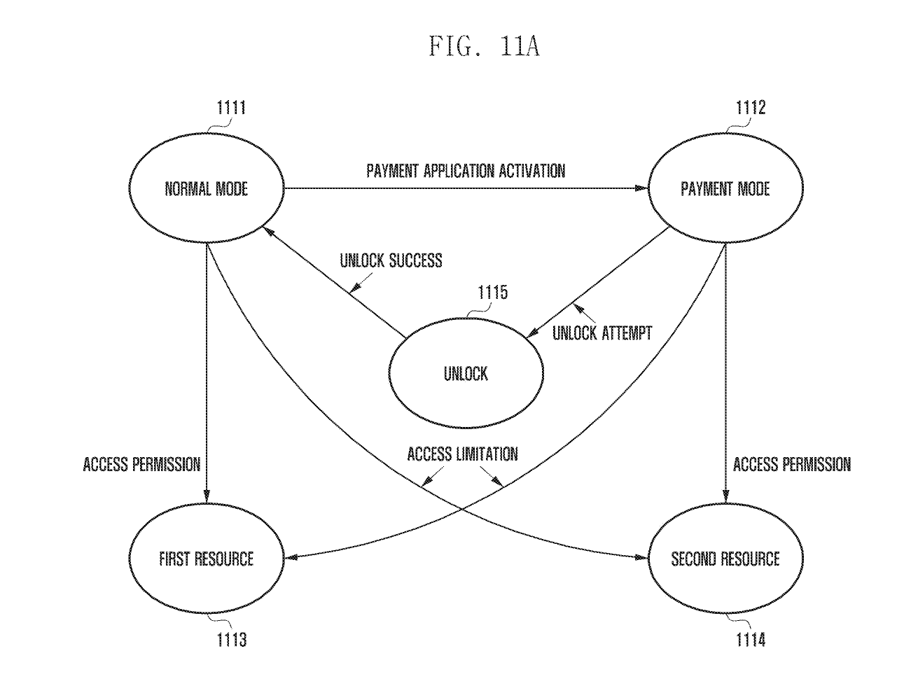

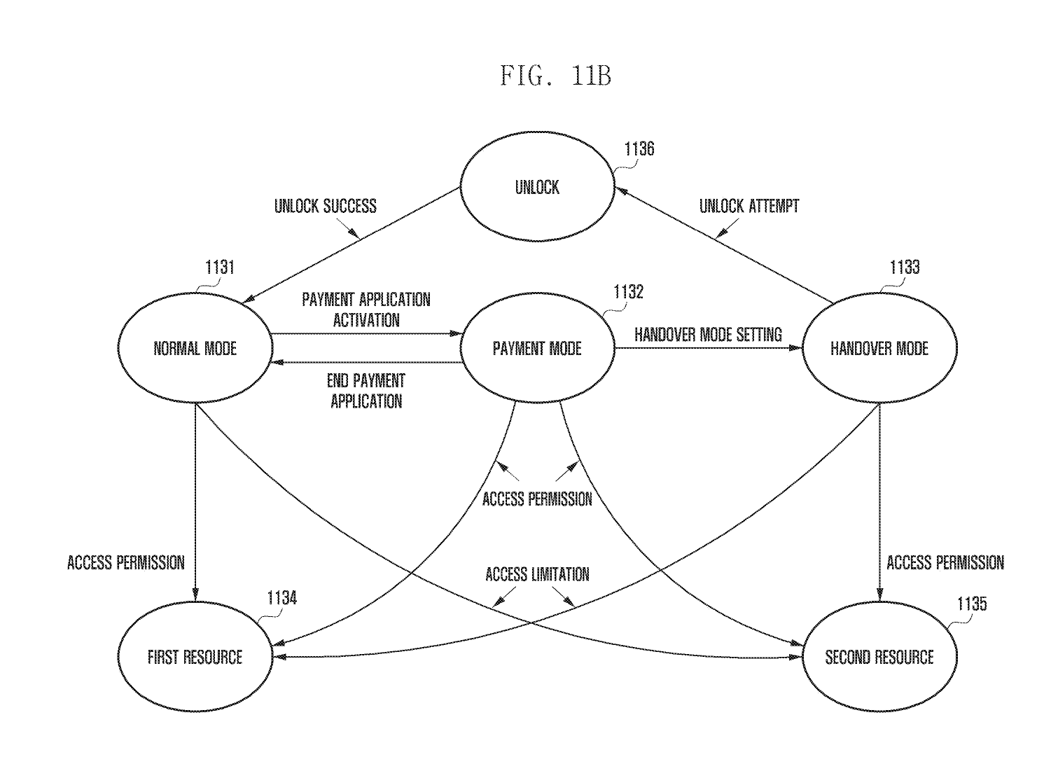

FIG. 11A is a state diagram of an electronic device according to various embodiments of the present disclosure.

Referring to FIG. 11A, when the electronic device 800 operates in a normal mode 1111, it limits access to a second resource 1114 related to payment, but allows access to a first resource 1113 unrelated to payment. When the payment application is activated and the electronic device 800 thus operates in a payment mode 1112, the electronic device 800 limits access to the first resource 1113 but permits access to the second resource 1114. In order to switch from the normal mode 1111 to the payment mode 1112, the electronic device 800 needs a condition where the payment application is activated. Since the electronic device 800 limits access to the first resource 1113 in the payment mode 1112, it needs to additionally perform a lock release (UNLOCK) 1115 in order to switch from the payment mode 1112 to the normal mode 1111.

FIG. 11B is a state diagram of an electronic device in a handover mode according to various embodiments of the present disclosure.

Referring to FIG. 11B, when the electronic device 800 operates in a normal mode 1131, it limits access to a second resource 1135 related to payment, but allows access to a first resource 1134 unrelated to payment. When the payment application is activated and the electronic device 800 thus operates in a payment mode 1132, the electronic device 800 allows access to both of the first resource 1134 and the second resource 1135. When a handover mode is set to be in use and the electronic device 800 thus operates in a handover mode 1133, the electronic device 800 limits access to the first resource 1134, but permits access to the second resource 1135. Since the electronic device 800 allows access to the first resource 1134 in the payment mode 1132, when the payment application is ended, the electronic device 800 becomes the normal mode 1131. Since the electronic device 800 limits access to the first resource 1134 in the handover mode 1133, it needs to additionally perform a lock release (UNLOCK) 1136 in order to switch from the handover mode 1133 to the normal mode 1131.

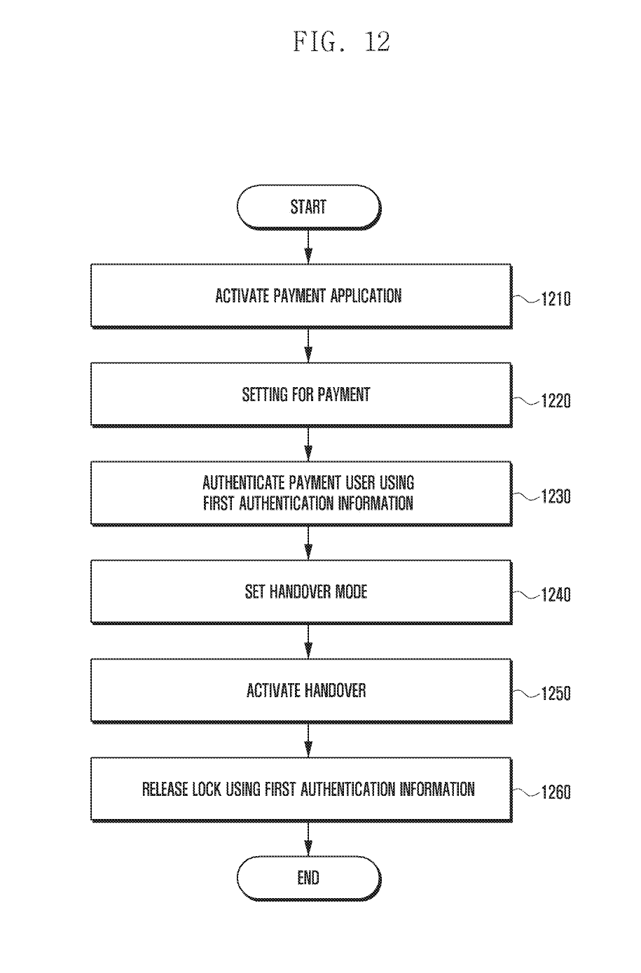

FIG. 12 is a flowchart that describes a first example of a secure payment method according to various embodiments of the present disclosure. Although the first example of a secure payment method according to the present disclosure is described based on an embodiment using the electronic device 800 referring to FIG.13, it should be understood that the present disclosure is not limited to the embodiment.

Referring to FIG. 12, the processor 810 activates an application to perform a payment (payment application) in operation 1210. In various embodiments, the payment application may be activated by at least one of the following: a manual input by a user, an automatic input by an occurrence of a preset event, or a combination of the manual input and the automatic input.

FIG. 13 illustrate diagrams that describe the first example of a secure payment method shown in FIG. 12 according to various embodiments of the present disclosure.

As shown in diagram (a) of FIG. 13, the processor 810 displays a payment application on the home screen. In various embodiments, the payment application displayed on the home screen may be activated by a user's manual input. Although it is not shown in FIG. 13, the payment application may be activated by various types of inputs as described above referring to FIG. 9.

The processor 810 configures the settings for payment in operation 1220. The payment application may provide a payment-related UI, e.g., a UI, a UX, etc. An example of the payment-related UI is a wallet user interface (wallet UI/UX). The process for configuring the settings for payment may be omitted or may be optionally or additionally performed. For example, the processor 810 may authenticate a payment user using first authentication information right after the payment application is activated.

In various embodiments, the electronic device 800 is capable of previously designating (registering) a user's fingerprint and a card to make a payment. For example, when a user performs authentication with fingerprints using a payment application, he/she may have designated the right hand's thumb and index finger for a Visa card and a Master card, respectively. Therefore, the card can be used to make a payment when the user's fingerprint is authenticated.

As shown in diagram (b) of FIG. 13, the processor 810 displays a user interface on the display so that the user of the electronic device 800 can set a payment means. For example, the electronic device user selects a payment means (e.g., at least one of a number of registered cards) and also an MST mode and/or an NFC mode according to types of POS terminal (reader). In addition, the UI of the electronic device 800 that allows the user to set a payment means may be altered, based on a resource functionally connected to the electronic device 800. For example, when the electronic device 800 is equipped with only an NFC module, the UI may display text or an icon (e.g., an image) related to the NFC mode, without displaying text or an icon (e.g., an image) related to the MST mode. When the UI displays, on the display 860, a payment mode (e.g., MST mode or˜˜(NST) mode) which can be used according to types of POS terminal (reader), it is capable of displaying a resource functionally connected to the electronic device 800, distinguished from a resource not functionally connected to the electronic device 800. For example, the UI may display an icon corresponding to a resource not functionally connected to the electronic device 800 lighter in color than that corresponding to a resource functionally connected to the electronic device 800.

In various embodiments, the UI of the electronic device 800 that allows the user to set a payment means may be altered, based on information contained in the payment means (e.g., a policy). For example, for a card (e.g., card B) which has not been used in an NFC mode of the payment means, the UI may display an icon related to the NFC mode lighter in color than that related to the MST mode. The icon related to the NFC mode may not respond to an external input (e.g., a user input) or may not be used for a payment function. The electronic device 800 is capable of receiving the policy (information contained in the payment means) from a server for performing a payment function (e.g., a payment server 420) and storing it therein.

As shown in diagram (c) of FIG. 13, the processor 810 displays a UI which allows the electronic device user to input additional information for payment. For example, the UI allows the electronic device user to set: a payment limit to prevent a person, who received the electronic device from the electronic device user, from making a payment with an amount; a time limit to prevent payment from being made when it has elapsed; or a place limit so that payment can be made only within a certain range, e.g., in a store, etc. When a time limit has elapsed or the electronic device is out of a place limit, the processor 810 is capable of controlling the display 860 to display the information regarding a place limit or a time limit on the screen. When an attempt is made to make a payment with an amount over the payment limit, the processor 810 is capable of controlling the display 860 to display a message informing that the amount exceeds the payment limit on the screen.

The processor 810 authenticates a payment user using first authentication information for payment in operation 1230. For example, the processor 810 may provide a UI to perform user authentication via identification and verification (ID&V). In addition, the process of authenticating a payment user using first authentication information may be optionally or additionally performed according to the settings. The process of authenticating a payment user using first authentication information may be omitted with respect to a small amount payment, etc. The processor 810 may perform a setting for using a handover mode right after the settings for payment is completed. The embodiment may be modified in such a way to perform operation 1240 after operation 1210, without performing operations 1220 and 1230.

As shown in diagram (d) of FIG. 13, the processor 810 displays a UI for receiving information to authenticate a payment user (e.g., a PIN or a fingerprint input via a fingerprint sensor). Although it is not shown, the electronic device 800 may also receive a user's biometric information to perform user authentication (e.g., iris) via a biometric module.

The processor 810 is capable of receiving an input for selecting a condition as to whether it limits access to a resource unrelated to payment (or an input for setting the use of “handover mode”) in operation 1240. The operation of 1240 may be mandatory in the electronic device 800, regardless of a user's option, according to policies of electronic device manufacturers, communication service companies, card issuing companies, etc. to increase the security. For example, the processor 810 may activate a handover mode right after authenticating a payment user using first authentication information. The embodiment may be modified in such a way to perform operation 1250 after operation 1210, without performing operations 1220, 1230 and 1240 or a combination thereof.

As shown in diagram (e) of FIG. 13, the processor 810 displays, on the screen, a user interface for allowing the user to select a condition as to whether to limit access to a resource unrelated to payment (or to set the use of “handover mode”).

In various embodiments, the condition as to whether to limit access to a resource unrelated to payment may be select by a biometric module. For example, in a state where a payment user's biometric information is stored in the electronic device, when the processor 810 ascertains that received biometric information differs from the stored, payment user's biometric information, it may automatically limit access to a resource unrelated to payment. Examples of the payment user's biometric information are fingerprint, iris, facial image, voice, heartbeat pattern, blood pressure, etc.

When access to a resource unrelated to payment is not restricted, the electronic device 800 may operate in a state, e.g., in a mode displaying a screen shown in FIG. 7.

When the user selects an input for limiting access to a resource unrelated to payment, the processor 810 limits access to a first resource unrelated to payment, and performs at least a part of the functions related to payment execution via a second resource related to payment (or activates a “handover mode”) in operation 1250.

In various embodiments, the processor 810 performs at least a part of the functions related to payment, based on preset payment conditions, in operation 1250. The payment conditions may contain: information received from an external device based on payment-related policy; time to perform payment, set to the payment application; location information regarding the electronic device; a payment limit set to the payment application; or a combination thereof.

As shown in diagram (f) of FIG. 13, the user interface displays, on the screen, a state of a screen locked and a message asking the user to hold the electronic device 800 close to a POS terminal (reader). When the user does not need to make a payment, he/she may unlock the screen and cancel payment execution. In this case, the electronic device displays information regarding various states on the screen. When the user of an electronic device 800 or a person who receives the electronic device 800 from the user holds the electronic device 800 close to a POS terminal (reader), the electronic device 800 receives information received from the POS terminal (reader) and displays the received information on the screen.

As shown in diagram (g) of FIG. 13, the user interface displays a message notifying that payment has been completed on the display 160. Although it is not shown, the UI may also display, on the screen, information notifying of various states, e.g., a message notifying of payment failure according to various payment states, a message notifying that a time limit has elapsed, etc.

The user may release restriction of access to a first resource, using first authentication information in operation 1260. In an embodiment, the first authentication information may be identical or similar to that used for a method of authenticating a payment user.

As shown in diagram (h) of FIG. 13, the user interface displays a state of the screen unlocked using the first authentication information. When the screen is unlocked, the processor 810 returns back to a process for setting payment and may display a home screen, etc., according to the settings. The processor 810 is capable of controlling the display 860 to display at least one of a number of payment means (e.g., a number of registered cards) in such a way that a card which has performed a payment (e.g., card B) and a card which has not performed a payment (e.g., card A) are distinguished from each other. For example, the processor 810 may activate a card which has performed a payment and may inactivate a card which has not performed a payment. When a card has not performed a payment and thus the corresponding icon (e.g., a card icon) has been inactivated in the UI, the processor 810 may display part of the icon corresponding to the card which has not performed a payment lighter in color than an icon corresponding to a card which has performed a payment. In addition, the processor 810 may set the card which has performed a payment as a default card for payment.

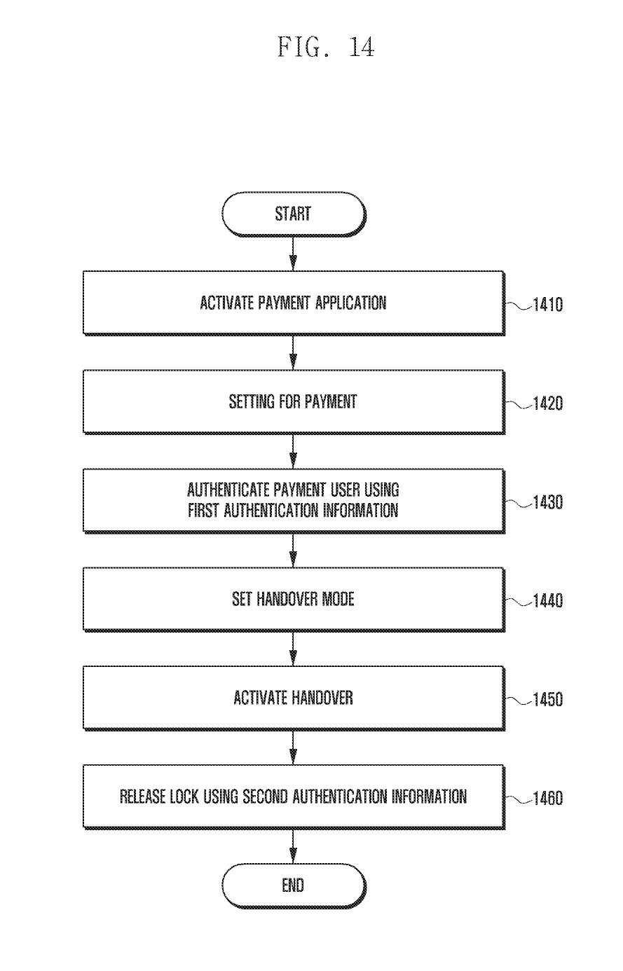

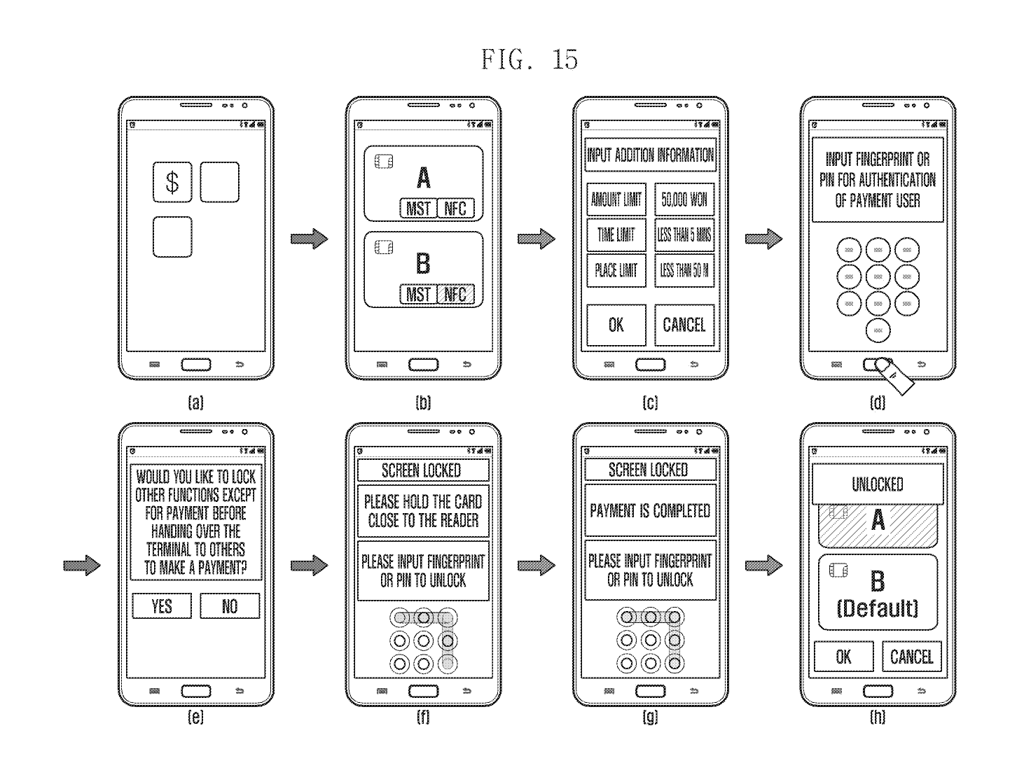

FIG. 14 is a flowchart that describes a second example of a secure payment method according to various embodiments of the present disclosure. Although the second example of a secure payment method according to the present disclosure is described based on an embodiment using the electronic device 800 referring to FIG. 15 to FIG. 17, it should be understood that the present disclosure is not limited to the embodiment.

Referring to FIG. 14, the processor 810 activates an application to perform a payment (payment application) in operation 1410. The process of activating a payment application is similar to operation 1210 of the embodiment referring to FIGS. 13A to 13H, and its detailed description will be explained referring thereto.

FIG. 15 illustrate diagrams that describe the second example of a secure payment method shown in FIG. 14 according to various embodiments of the present disclosure.

Referring to diagram (a) of FIG. 15, the processor 810 displays a payment application on the home screen. In various embodiments, the payment application displayed on the home screen may be activated by a user's manual input. Although it is not shown in FIG. 15, the payment application may also be activated by various types of inputs described above referring to FIG. 9.

The processor 810 configures the settings for payment in operation 1420. The process of configuring the settings for payment is similar to operation 1220 of the embodiment referring to FIG. 13, and its detailed description will be explained referring thereto. The process for configuring the settings for payment may be omitted or may be optionally or additionally performed. For example, the processor 810 may authenticate a payment user using first authentication information right after the payment application is activated.

In various embodiments, the electronic device 800 is capable of previously designating (registering) a user's fingerprint and a card to make a payment. For example, when a user performs authentication with fingerprints using a payment application, he/she may have designated the right hand's thumb and index finger for a Visa card and a Master card, respectively. Therefore, the card can be used to make a payment when the user's fingerprint is authenticated.

Referring to diagram (b) of FIG. 15, the processor 810 displays a user interface on the display so that the user of the electronic device 800 can set a payment means. For example, the electronic device user selects a payment means (e.g., at least one of a number of registered cards) and also an MST mode and/or an NFC mode according to types of POS terminal (reader).

In addition, the UI of the electronic device 800 that allows the user to set a payment means may be altered, based on a resource functionally connected to the electronic device 800. For example, when the electronic device 800 is equipped with only an NFC module, the UI may display text or an icon (e.g., an image) related to the NFC mode, without displaying text or an icon (e.g., an image) related to the MST mode. When the UI displays, on the display 860, a payment mode (e.g., MST mode or NST mode) which can be used according to types of POS terminal (reader), it is capable of displaying a resource functionally connected to the electronic device 800, distinguished from a resource not functionally connected to the electronic device 800. For example, the UI may display an icon corresponding to a resource not functionally connected to the electronic device 800 lighter in color than that corresponding to a resource functionally connected to the electronic device 800.

In various embodiments, the UI of the electronic device 800 that allows the user to set a payment means may be altered, based on information contained in the payment means (e.g., a policy). For example, for a card (e.g., card B) which has not been used in an NFC mode of the payment means, the UI may display an icon related to the NFC mode lighter in color than that related to the MST mode. The icon related to the NFC mode may not respond to an external input (e.g., a user input) or may not be used for a payment function. The electronic device 800 is capable of receiving the policy (information contained in the payment means) from a server for performing a payment function (e.g., a payment server 420) and storing it therein.

Referring to diagram (c) of FIG. 15, the processor 810 displays a user interface which allows the electronic device user to input additional information for payment. For example, the UI allows the electronic device user to set: a payment limit to prevent a person, who received the electronic device from the electronic device user, from making a payment with an amount; a time limit to prevent payment from being made when it has elapsed; or a place limit so that payment can be made only within a certain range, e.g., in a store, etc. When a time limit has elapsed or the electronic device is out of a place limit, the processor 810 is capable of controlling the display 860 to display the information regarding a place limit or a time limit on the screen. When an attempt is made to make a payment with an amount over the payment limit, the processor 810 is capable of controlling the display 860 to display a message informing that the amount exceeds the payment limit on the screen.

The processor 810 authenticates a payment user using first authentication information for payment in operation 1430. In various embodiments, an environment where a relatively high level of security is required may also employ operation 1430. For example, the electronic device 800 may store the user's first authentication information (e.g., biometric information) in the TrustZone or security module, and compares received information with the stored first authentication information to authenticate the user. In addition, the process of authenticating a payment user using first authentication information may be optionally or additionally performed according to the settings. The process of authenticating a payment user using first authentication information may also be omitted with respect to a small amount payment, etc. The processor 810 may perform a setting for using a handover mode right after the settings for payment is completed. The embodiment may be modified in such a way to perform operation 1440 after operation 1410, without performing operations 1420 and 1430.

Referring to diagram (d) of FIG. 15, the processor 810 displays a user interface for receiving information to authenticate a payment user (e.g., a PIN or a fingerprint input via a fingerprint sensor). Although it is not shown, the electronic device 800 may also receive a user's biometric information to perform user authentication (e.g., iris) via a biometric module.

The processor 810 is capable of receiving an input for selecting a condition as to whether it limits access to a resource unrelated to payment (or an input for setting “handover mode”) in operation 1440. The process of selecting a condition as to whether it limits access to a resource unrelated to payment is similar to operation 1240 of the embodiment referring to FIG. 13. The operation of 1440 may be mandatory in the electronic device 800, regardless of a user's option, according to policies of electronic device manufacturers, communication service companies, card issuing companies, etc. to increase the security. For example, the processor 810 may activate a handover mode right after authenticating a payment user using first authentication information. The embodiment may be modified in such a way to perform operation 1450 after operation 1410, without performing operations 1420, 1430 and 1440 or a combination thereof.

Referring to diagram (e) of FIG. 15, the processor 810 displays, on the screen, a user interface for allowing the user to select a condition as to whether to limit access to a resource unrelated to payment.

In various embodiments, the condition as to whether to limit access to a resource unrelated to payment may be select by a biometric module. For example, in a state where a payment user's biometric information is stored in the electronic device, when the processor 810 ascertains that received biometric information differs from the stored, payment user's biometric information, it may automatically limit access to a resource unrelated to payment. Examples of the payment user's biometric information are fingerprint, iris, facial image, voice, heartbeat pattern, blood pressure, etc.

When access to a resource unrelated to payment is not restricted, the electronic device 800 may operate in a state, e.g., in a mode displaying a screen shown in FIG. 7.

When the user selects an input for limiting access to a resource unrelated to payment, the processor 810 limits access to a first resource unrelated to payment, and performs at least a part of the functions related to payment execution via a second resource related to payment (or activates a “handover mode”) in operation 1450. Operation 1450 is similar to operation 1250 described above referring to FIG. 13 and its detailed description refers thereto.

Referring to diagram (f) of FIG. 15, the user interface displays, on the screen, a state of a screen locked and a message asking the user to hold the electronic device 800 close to a POS terminal (reader). When the user does not need to make a payment, he/she may unlock the screen and cancel payment execution. In this case, the electronic device displays information regarding various states on the screen. When the user of an electronic device 800 or a person who receives the electronic device 800 from the user holds the electronic device 800 close to a POS terminal (reader), the electronic device 800 receives information received from the POS terminal (reader) and displays the received information on the screen.

Referring to diagram (g) of FIG. 15, the user interface displays a message notifying that payment has been completed on the display 160. Although it is not shown, the user interface may also display, on the screen, information notifying of various states, e.g., a message notifying of payment failure according to various payment states, a message notifying that a time limit has elapsed, etc.

The user may release restriction of access to a first resource, using second authentication information in operation 1460. In an embodiment, the second authentication information is used to unlock the screen and may be used in an environment where a relatively low level of security is required, in comparison with the first authentication information.

In various embodiments, the second authentication information may be a lock pattern for unlocking a payment screen or a one-time password (OTP).

Referring to diagram (h) of FIG. 15, the user interface displays a state when the screen is unlocked using the first authentication information. When the screen is unlocked, the processor 810 returns back to a process for setting payment and may display a home screen, etc., according to the settings. The processor 810 is capable of controlling the display 860 to display at least one of a number of payment means (e.g., a number of registered cards) in such a way that a card which has performed a payment (e.g., card B) and a card which has not performed a payment (e.g., card A) are distinguished from each other. For example, the processor 810 may activate a card which has performed a payment and may inactivate a card which has not performed a payment. When a card has not performed a payment and thus the corresponding icon (e.g., a card icon) has been inactivated in the UI, the processor 810 may display part of the icon corresponding to the card which has not performed a payment lighter in color than an icon corresponding to a card which has performed a payment. In addition, the processor 810 may set the card which has performed a payment as a default card for payment.

In various embodiments, a secure payment method of an electronic device includes: activating a payment application for making a payment; limiting access to a first resource unrelated to payment, based on the activated payment application; and performing at least a part of the functions related to payment, using a second resource related to payment, while limiting access to the first resource.

In various embodiments, the resources of the secure payment method include: hardware functionally connected to the electronic device, software executed via the hardware, instructions (messages) executed by a processor of the electronic device, and a combination of the hardware, software and instructions (messages).

In various embodiments, the payment application is activated according to a manual input by a user, an automatic input by an occurrence of a preset event or a combination of the manual input and the automatic input.

In various embodiments, the preset event occurs, based on the motion of the electronic device, security information set to the electronic device, location information regarding the electronic device, information obtained by a number of sensors of the electronic device, instructions received from an external electronic device, or a combination thereof.

In various embodiments, at least a part of the functions related to payment is performed, based on a preset payment condition.

In various embodiments, the payment condition includes: information received from an external device based on payment-related policy, time to perform payment, set to the payment application, location information regarding the electronic device, a payment limit set to the payment application, or a combination thereof.

In various embodiments, the payment condition is set to the electronic device, based on a user input.

In various embodiments, the payment application includes a first UI and a second UI. The process of performing at least a part of the functions related to payment includes: displaying the first UI related to the payment execution; and limiting switching from the first UI to the second UI unrelated to the payment execution, during the payment execution.

In various embodiments, the process of performing at least a part of the functions related to payment includes: obtaining information regarding a card related to the payment; and transmitting or receiving the obtained card information to or from an external electronic device.

In various embodiments, the electronic device includes an electronic device of a buyer that performs the payment via an external device. The external device includes an electronic device of a seller that performs the payment.

In various embodiments, the process of limiting access to the first resource unrelated to payment includes: activating a handover mode; and limiting access to the first resource unrelated to payment, based on the activation of a handover mode.

In various embodiments, the process of activating a handover mode includes: selecting a handover mode, inputting a PIN, inputting a payment user's unique pattern, inputting biometric information of a payment user, or a combination thereof.

In various embodiments, the secure payment method further includes: receiving an input for releasing the limitation of access to the first resource.

In various embodiments, the secure payment method further includes: receiving an input for authenticating a payment user; and receiving an input for releasing the limitation of access to the first resource. The input for releasing the limitation of access to the first resource includes: an input that differs from an input for authenticating the payment user, an OTP or a combination thereof.

In various embodiments, a computer-readable recording medium stores a software program for executing the following processes of: activating a payment application for making a payment; limiting access to a first resource unrelated to payment, based on the activated payment application; and performing at least a part of the functions related to payment, using the second resource related to payment, while limiting access to the first resource.

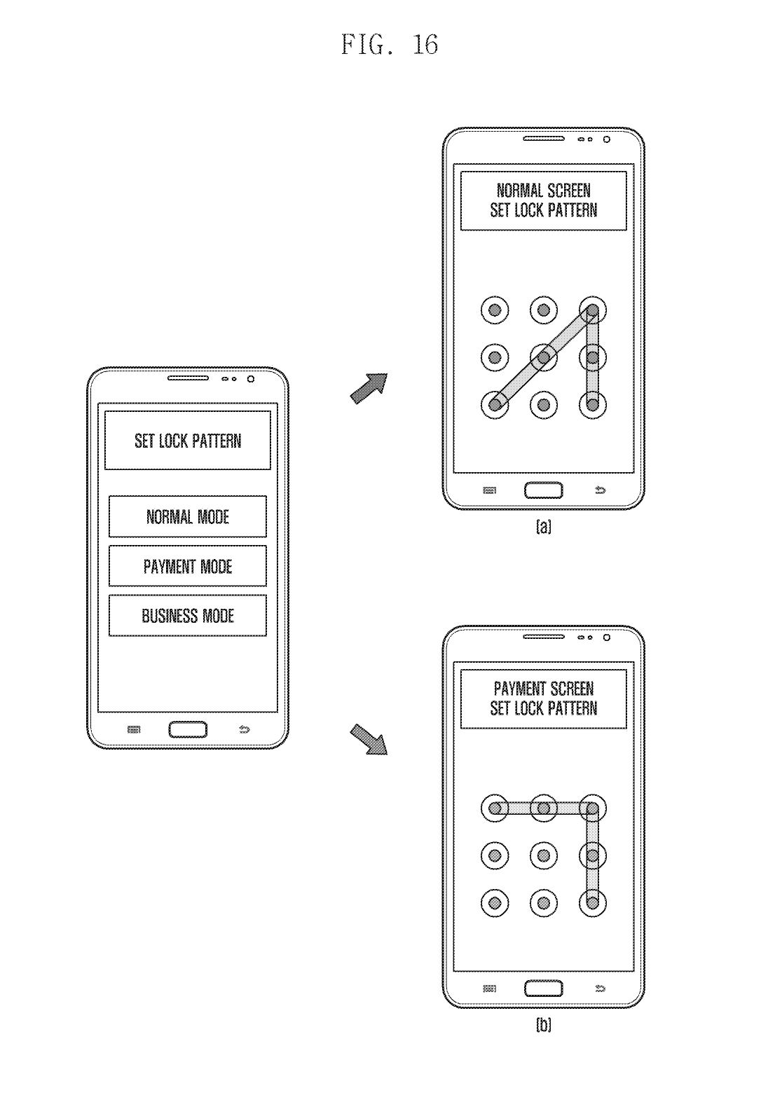

FIG. 16 illustrate diagrams that describe a method of setting a lock pattern for a payment screen according to various embodiments of the present disclosure. Lock patterns may be set to be different from each other, according to a normal mode, a payment mode or a business mode. Referring to FIG. 16, a lock pattern for a normal screen (a normal screen lock pattern shown in diagram (a)) and a lock pattern for a payment screen (a payment screen lock pattern shown in diagram (b)) are set to be different from each other. In various embodiments, when the user needs to switch from a payment mode to a normal mode, he/she may unlock the screen in a payment mode using a payment screen lock pattern shown in diagram (b), and the screen in a normal mode using a normal screen lock pattern shown in diagram (a).

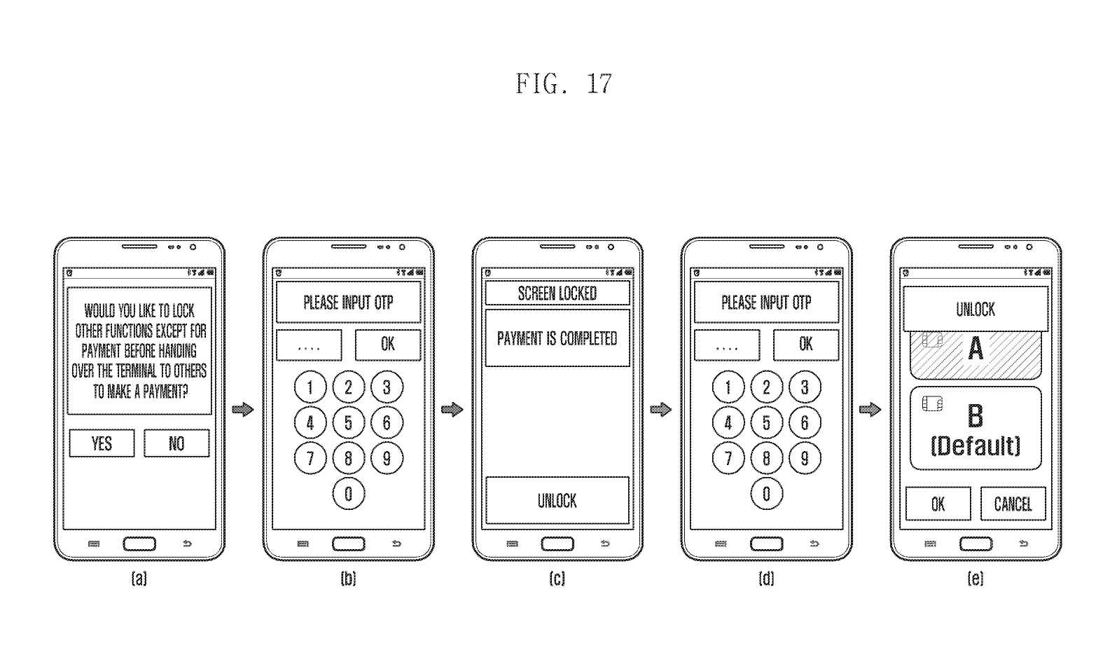

FIG. 17 illustrates diagrams that describe a method of using a one-time password (OTP) according to various embodiments of the present disclosure. The electronic device 800 displays a user interface that allows the user to select a condition as to whether to limit access to a resource unrelated to payment on the screen as shown in diagram (a). When the user selects a condition for limiting access to a resource unrelated to payment, the electronic device 800 displays a user interface for allowing the user to set a one-time password on the screen as shown in diagram (b). After payment is completed, the electronic device 800 displays a user interface showing a message informing of payment completion on the screen as shown in diagram (c). Although it is not shown, it should be understood that the electronic device may display messages according to various states after the payment completion. When the electronic device displays an OTP input user interface for unlocking the screen on the screen as shown in diagram (d), the user may input a preset OTP. When the locked screen is unlocked, the electronic device displays a user interface before performing a payment on the screen as shown in diagram (e). Although it is not shown, when the locked screen is unlocked, the electronic device may be set to display various screens, e.g., a home screen.

In the present disclosure, the terminology ‘module’ refers to a ‘unit’ including hardware, software, firmware or a combination thereof. For example, the terminology ‘module’ is interchangeable with ‘unit,’ ‘logic,’ ‘logical block,’ ‘component,’ ‘circuit,’ or the like. A ‘module’ may be the smallest unit or a part of an integrated component. A ‘module’ may be the smallest unit or a part thereof that can perform one or more functions. A ‘module’ may be implemented in mechanical or electronic mode. For example, a ‘module’ may include at least one of the following: an application specific integrated circuit (ASIC) chip, field-programmable gate array (FPGAs) and a programmable-logic device that can perform functions that are known or will be developed.

At least a part of the method (e.g., operations) or devices (e.g., modules or functions) according to various embodiments may be implemented with instructions that can be conducted via various types of computers and stored in computer-readable storage media, as types of programming modules, for example. One or more processors (e.g., processor 120) can execute command instructions, thereby performing the functions. An example of the computer-readable storage media may be memory 130.

Examples of computer-readable media include: magnetic media, such as hard disks, floppy disks, and magnetic media (e.g., magnetic tape); optical media such as compact disc ROM (CD-ROM) disks and DVD; magneto-optical media, such as floptical disks; and hardware devices such as ROM, RAM, flash memory, etc. Examples of program instructions include machine code instructions created by assembly languages, such as a compiler, and code instructions created by a high-level programming language executable in computers using an interpreter, etc. The described hardware devices may be configured to act as one or more software modules to perform the operations of various embodiments described above, or vice versa.

In various embodiments, a computer-readable recording medium stores instructions which enable at least one processor to execute the following processes of: activating a payment application for making a payment in an electronic device; limiting access to a first resource unrelated to payment, based on the activated payment application; and performing at least a part of the functions related to payment, using the second resource related to payment, while limiting access to the first resource.

Modules or programming modules according to various embodiments may include one or more components, remove part of them described above, or further include new components. The operations performed by modules, programming modules, or other components, according to various embodiments, may be executed in serial, parallel, repetitive or heuristic fashion. Part of the operations can be executed in any other order, skipped, or executed with additional operations.

The embodiments of the present disclosure are merely provided to assist in a comprehensive understanding of the present disclosure and not suggestive of limitation. Therefore, it should be understood that many variations and modifications of the basic inventive concept herein described will still fall within the spirit and scope of the embodiments of the present disclosure as defined in the appended claims.

As described above, various embodiments of the present disclosure are capable of limiting access to resources unrelated to payment when offline payment using an electronic device is made, thereby maintaining a high level of security against hacking, malicious codes, etc.

In addition, various embodiments of the present disclosure do not allow a person, who received an electronic device from the electronic device owner, to access functions unrelated to a payment process, thereby preventing the electronic device owner's privacy information or security-related information from being invaded.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for making a payment of an electronic device capable of providing a plurality of resources including first and second resources, the method comprising:
activating a payment application for making a payment;
limiting access to the first resource, based on the activated payment application; and
performing at least one function related to the payment, using the second resource related to the payment, while limiting access to the first resource.

2. The method of claim 1, wherein the first and second resources comprise at least one of:
hardware functionally connected to the electronic device,
software executed via the hardware,
instructions (messages) executed by a processor of the electronic device, and
any combination of the hardware, software and instructions.

3. The method of claim 1, wherein the activating of the payment application comprises activating a payment application for making a payment, according to a manual input by a user, an automatic input by an occurrence of a preset event, or a combination thereof.

4. The method of claim 3, wherein the preset event comprises at least one event that occurs based on a motion of the electronic device, security information set for the electronic device, location information regarding the electronic device, information obtained by a plurality of sensors of the electronic device, instructions received from an external electronic device, or any combination thereof.

5. The method of claim 1, wherein the performing of the at least one function related to the payment comprises:
performing the at least one function related to the payment, based on a preset payment condition.

6. The method of claim 5, wherein the preset payment condition comprises at least one of:
information received from an external device based on a payment-related policy,
time to perform the payment, set to the payment application,
location information regarding the electronic device,
a payment limit set to the payment application, or
any combination thereof.

7. The method of claim 5, wherein the preset payment condition is set to the electronic device, based on a user input.

8. The method of claim 1,
wherein the payment application comprises a first user interface and a second user interface; and
wherein the performing of the at least one function related to the payment comprises:
displaying the first user interface related to a payment execution; and
limiting switching from the first user interface to the second user interface, during the payment execution.

9. The method of claim 1, wherein the performing of the at least one function related to payment comprises:
obtaining information regarding a card related to the payment; and
transmitting or receiving the obtained card information to or from an external electronic device.

10. The method of claim 1, wherein the electronic device comprises:
an electronic device of a buyer that performs the payment via an external device to the electronic device; and
an electronic device of a seller that performs the payment via the external electronic device.

11. The method of claim 1, wherein the limiting of the access to the first resource comprises:
activating a handover mode; and
limiting access to the first resource, based on an activation of a handover mode.

12. The method of claim 11, wherein the activating of the handover mode comprises:
selecting the handover mode among a plurality of handover modes,
inputting a personal identification number (PIN),
inputting a payment user's unique pattern,
inputting biometric information of a payment user, or
any combination thereof.

13. The method of claim 1, further comprising:
receiving an input for releasing the limitation of access to the first resource.

14. The method of claim 13, wherein the receiving of the input for releasing the limitation of access to the first resource comprises:
a PIN input, a payment user's unique pattern, biometric information of a payment user, or a combination thereof.

15. The method of claim 1, further comprising:
receiving an input for authenticating a payment user; and
receiving an input for releasing the limitation of access to the first resource,
wherein the input for releasing the limitation of access to the first resource comprises an input that differs from an input for authenticating the payment user, a one-time password or a combination thereof.

16. An electronic device comprising:
a memory configured to store information regarding a plurality of resources including first and second resources;
a transceiver configured to transmit or receive payment information to or from an external device;
a display for displaying a user interface; and
a processor configured for:
activating a payment application for making a payment;
limiting access to the first resource, based on the activated payment application; and
performing at least one function related to the payment, using the second resource related to the payment, while limiting access to the first resource.

17. The electronic device of claim 16, wherein the payment application is activated, based on a manual input by a user, an automatic input by an occurrence of a preset event or a combination thereof.

18. The electronic device of claim 17, wherein the preset event comprises at least one event that occurs based on a motion of the electronic device, security information set for the electronic device, location information regarding the electronic device, information obtained by a plurality of sensors of the electronic device, instructions received from an external electronic device, or any combination thereof.

19. The electronic device of claim 16, wherein the at least one function related to the payment is performed based on a preset payment condition.

20. The electronic device of claim 19, wherein the preset payment condition comprises at least one of:
information received from an external device based on a payment-related policy,
time to perform the payment, set to the payment application,
location information regarding the electronic device,
a payment limit set to the payment application, or
any combination thereof.

21. The electronic device of claim 19, wherein the preset payment condition is set to the electronic device, based on a user input.

22. The electronic device of claim 16, wherein the processor is further configured to:
control the display to display a first user interface related to a payment execution; and
limit switching from the first user interface to the second user interface during the payment execution.

23. The electronic device of claim 16, further comprising:
a security module for obtaining information regarding a card related to the payment,
wherein the processor is further configured to control the transceiver to transmit or receive the obtained card information to or from an external electronic device.

24. The electronic device of claim 16, wherein the processor is further configured to activate a handover mode and limit access to the first resource, based on the activation of a handover mode.

25. The electronic device of claim 24, wherein the handover mode is activated, based on an input selecting a handover mode, an input PIN, a payment user's unique pattern, biometric information of a payment user, or any combination thereof.

26. The electronic device of claim 16, wherein the processor is further configured to receive an input for releasing the limitation of access to the first resource.

27. The electronic device of claim 26, wherein the processor is further configured to receive the input for releasing the limitation of access to the first resource and returns to a state before the payment application is activated.

28. The electronic device of claim 26, wherein the input for releasing the limitation of access to the first resource comprises at least one of the following:
a PIN, a payment user's unique pattern, biometric information of a payment user, or any combination thereof.

29. The electronic device of claim 16,
wherein the processor is further configured to:
receive an input for authenticating a payment user; and
receive an input for releasing the limitation of access to the first resource; and
wherein the input for releasing the limitation of access to the first resource comprises an input that differs from an input for authenticating the payment user, a one-time password or a combination thereof.

30. A non-transitory computer-readable recording medium for storing a program that, when executed, causes at least one processor to perform a method, the method comprising:
activating a payment application for making a payment;
limiting access to a first resource, based on the activated payment application; and
performing at least one function related to the payment, using the second resource related to the payment, while limiting access to the first resource.
